(19) United States
(12) Patent Application Publication
(10) Pub. No.: US 2026/0238921 A1
(43) Pub. Date: Aug. 13, 2026

(54) SOUND REPRODUCTION METHOD, SOUND REPRODUCTION DEVICE, AND NON-TRANSITORY COMPUTER READABLE RECORDING MEDIUM STORING SOUND REPRODUCTION PROGRAM

(71) Applicant: PANASONIC INTELLECTUAL PROPERTY MANAGEMENT CO., LTD., Osaka (JP)

(72) Inventors: Naho KITADA, Osaka (JP); Yoshikazu Horimoto, Osaka (JP); Takeshi Sakai, Hyogo (JP)

(21) Appl. No.: 19/637,215

(22) Filed: Apr. 2, 2026

Related U.S. Application Data
(63) Continuation of application No. PCT/JP2024/026078, filed on Jul. 22, 2024.

(30) Foreign Application Priority Data
Oct. 4, 2023 (JP) 2023-173014

(51) Int. Cl. H04R 3/00; G10L 21/0272

(52) U.S. Cl. CPC H04R 3/00; G10L 21/0272; H04R 2430/01

(57) ABSTRACT

The sound reproduction device synchronizes and reproduces a plurality of divided sound signals obtained by dividing a predetermined sound, acquires the number of people in each of a plurality of areas, controls volume of each of the plurality of divided sound signals according to the number of people in each of the plurality of areas, and outputs the plurality of divided sound signals to a speaker that emits a plurality of divided sounds converted from the plurality of divided sound signals to each of the plurality of areas.

### FIELD OF INVENTION

The present disclosure relates to a technique of reproducing sound.

### BACKGROUND ART

For example, Patent Literature 1 discloses a system for preventing eavesdropping on private conversations in a public space. In this system, a work-related or leisure group and an individual are detected. Then, in a region where there is a work-related or leisure group, volume of music is reduced, and a low frequency feature of the music is reduced. This means that people in the group can clearly hear each other's voice without the need to speak louder than sound of music, and a low frequency sound does not mask their conversation. Further, in a region where there is an individual, volume of music is increased, and a low-frequency sound (sound of running water) is added so that the individual cannot clearly hear a conversation of a work-related or leisure group.

However, in the above-described conventional technique, it is not considered to gather people outside a plurality of areas to the inside of the plurality of areas, and further improvement has been required.

Patent Literature 1: JP 2011-528445 A

### SUMMARY OF THE INVENTION

The present disclosure has been made to solve the above problem, and an object of the present disclosure is to provide a technique capable of gathering people outside a plurality of areas to the inside of the plurality of areas.

A sound reproduction method according to the present disclosure is a sound reproduction method in a computer, the sound reproduction method including synchronizing and reproducing a plurality of divided sound signals obtained by dividing a predetermined sound, and outputting the plurality of divided sound signals to a speaker that emits a plurality of divided sounds converted from the plurality of divided sound signals to each of a plurality of areas.

According to the present disclosure, people outside a plurality of areas can be gathered inside the plurality of areas.

### BRIEF DESCRIPTION OF THE DRAWINGS

FIG. 1 is a diagram illustrating an overall configuration of a sound reproduction system according to a first embodiment.

FIG. 2 is a block diagram illustrating a configuration of a sound reproduction device according to the first embodiment.

FIG. 3 is a diagram illustrating human voice and a frequency band of a musical instrument.

FIG. 4 is a first flowchart for explaining sound reproduction processing by the sound reproduction device according to the first embodiment of the present disclosure.

FIG. 5 is a second flowchart for explaining sound reproduction processing by the sound reproduction device according to the first embodiment of the present disclosure.

FIG. 6 is a diagram illustrating an example of a table in which the number of people detected in an area is associated with volume of a divided sound emitted into the area in a first modification example of the first embodiment.

FIG. 7 is a diagram illustrating an example of a table in which a plurality of sounds of different types (genres) are associated with types of divided sounds to be emitted into each area in a second modification example of the first embodiment.

FIG. 8 is a diagram illustrating an overall configuration of the sound reproduction system according to a second embodiment.

FIG. 9 is a block diagram illustrating a configuration of the sound reproduction device according to the second embodiment.

FIG. 10 is a diagram illustrating an overall configuration of the sound reproduction system according to a third embodiment.

FIG. 11 is a block diagram illustrating a configuration of the sound reproduction device according to the third embodiment.

FIG. 12 is a diagram illustrating an overall configuration of a video reproduction system according to a fourth embodiment.

FIG. 13 is a block diagram illustrating a configuration of a video reproduction device according to the fourth embodiment.

FIG. 14 is a first flowchart for explaining video reproduction processing by the video reproduction device according to the fourth embodiment of the present disclosure.

FIG. 15 is a second flowchart for explaining video reproduction processing by the video reproduction device according to the fourth embodiment of the present disclosure.

FIG. 16 is a diagram illustrating an overall configuration of the video reproduction system according to a modification example of the fourth embodiment.

FIG. 17 is a block diagram illustrating a configuration of the video reproduction device according to a modification example of the fourth embodiment.

### DETAILED DESCRIPTION

### Knowledge underlying present disclosure

Conventionally, people do not gather in a public place such as a park, and how to gather many people in a public place has been a problem.

In Patent Literature 1 described above, in a case where there is a customer in a work-related or leisure group in a first area and there is an individual customer in a second area adjacent to the first area, volume of music in the second area is increased and a sound of running water is added to the second area. By the above, in the second area, a conversation of people in the first area is masked, and eavesdropping on a private conversation in a public place is prevented.

However, in Patent Document 1, a person outside an area who hears a sound coming from the inside of the area does not always want to go to the inside of the area, and it does not consider gathering people outside a plurality of areas to the inside of the plurality of areas.

In order to solve the above problems, the following technique is disclosed.

(1) A sound reproduction method according to one aspect of the present disclosure is a sound reproduction method in a computer, the sound reproduction method including synchronizing and reproducing a plurality of divided sound signals obtained by dividing a predetermined sound, and outputting the plurality of divided sound signals to a speaker that emits a plurality of divided sounds converted from the plurality of divided sound signals to each of a plurality of areas.

According to this configuration, since a plurality of divided sounds that are synchronized and reproduced are emitted in each of a plurality of areas, the plurality of divided sounds overlap each other inside the plurality of areas, and one harmonious sound is heard. Therefore, since people outside the plurality of areas can be guided to the inside of the plurality of areas, the people outside the plurality of areas can be gathered to the inside of the plurality of areas.

(2) The sound reproduction method according to (1) above may further include acquiring the number of people in each of the plurality of areas, and controlling volume of each of the plurality of divided sound signals according to the number of people in each of the plurality of areas.

According to this configuration, for example, as the number of people in an area increases, volume of a divided sound emitted in the area can be increased. Therefore, it is possible to gather new people in an area with no people or an area with few people, and it is possible to guide people outside a plurality of areas to the area with no people or the area with few people.

(3) In the sound reproduction method according to (2) above, control of the volume may include determining volume of a divided sound signal to be a predetermined volume in a case where the number of people in an area is equal to or more than a predetermined number of people in each of the plurality of areas, and determining volume of the divided sound signal to be zero in a case where the number of people in the area is smaller than the predetermined number of people.

According to this configuration, it is possible to cause a divided sound to be emitted in an area where there is a person without causing a divided sound to be emitted in an area where there is no person. Then, when a new person enters an area where there is no person, a new divided sound is emitted, and a divided sound that is already emitted overlaps with the new divided sound, so that a person outside a plurality of areas can be guided to the area where there is no person.

(4) In the sound reproduction method according to any one of (1) to (3) above, the predetermined sound may be divided according to frequency.

According to this configuration, it is possible to cause a plurality of divided sound signals at a plurality of frequency bands to be emitted in each of a plurality of areas, and it is possible to cause one harmonious sound to be emitted by overlapping a plurality of divided sounds.

(5) In the sound reproduction method according to any one of (1) to (3) above, the predetermined sound may be music, and may be divided according to a plurality of performance parts forming the music.

According to this configuration, a plurality of divided sounds for a plurality of performance parts forming music can be emitted in each of a plurality of areas, and one piece of harmonious music can be emitted by overlapping the plurality of divided sounds.

(6) In the sound reproduction method according to any one of (1) to (3) above, the predetermined sound may be a natural sound, and may be divided according to a plurality of elements forming the natural sound.

According to this configuration, a plurality of divided sounds for a plurality of elements forming a natural sound can be emitted in each of a plurality of areas, and one harmonious natural sound can be emitted by overlapping the plurality of divided sounds.

(7) The sound reproduction method according to (2) or (3) above may further include causing a divided sound to be emitted toward the outside of an area in a case where there is no person in the area, and causing the divided sound to be emitted toward the inside of the area in a case where there is a person in the area for each of the plurality of areas.

According to this configuration, in each of a plurality of areas, in a case where there is no person in an area, a divided sound is emitted toward the outside of the area, so that it is possible to guide a person outside the area to the area where there is no person.

(8) In the sound reproduction method according to any one of (1) to (7) above, outputting the plurality of divided sound signals may include outputting each of the plurality of reproduced divided sound signals to each of a plurality of speakers installed in each of the plurality of areas.

According to this configuration, a plurality of divided sounds can be emitted from each of a plurality of speakers installed in a plurality of areas.

(9) In the sound reproduction method according to any one of (1) to (7) above, outputting the plurality of divided sound signals may include outputting each of the plurality of reproduced divided sound signals to at least one speaker array having directivity set to each of the plurality of areas.

According to this configuration, a plurality of divided sounds can be emitted from at least one speaker array whose directivity is set toward each of a plurality of areas.

(10) The sound reproduction method according to (2) or (3) above may further include changing the predetermined sound according to the total number of people in the plurality of areas.

According to this configuration, for example, in a case where the total number of people in all of a plurality of areas is smaller than a threshold, quiet music is selected as the predetermined sound, and in a case where the total number of people in all of the plurality of areas is equal to or more than the threshold, lively music is selected as the predetermined sound, so that the atmosphere in all of the plurality of areas can be changed according to the total number of people in all of the plurality of areas.

(11) The sound reproduction method according to (2) or (3) above may further include determining whether to emit each of the plurality of divided sounds to the inside or the outside of an area according to number of people in each of the plurality of areas or a total number of people in all of the plurality of areas.

According to this configuration, for example, in a plurality of areas, in a case where the number of people in an area is equal to or less than a predetermined number of people, a divided sound is emitted to the outside of the area, so that people outside the plurality of areas can be guided into the area. Further, for example, in a case where the total number of people in all of a plurality of areas is equal to or less than a predetermined number of people, each of a plurality of divided sounds is emitted to the outside of the plurality of areas, so that people outside the plurality of areas can be guided to the inside of the plurality of areas.

(12) The sound reproduction method according to (2) or (3) above may further include acquiring volume of voice of a person in each of the plurality of areas, in which control of the volume may include changing volume of each of the plurality of divided sound signals according to the volume of the voice in each of the plurality of areas.

According to this configuration, for example, by increasing volume of a divided sound signal as volume of voice of a person in an area increases, a divided sound can be ensured to be heard by the person in the area, and the voice of the person in the area can be masked.

(13) The sound reproduction method according to (2) or (3) above may further include acquiring an activity amount of a person in each of the plurality of areas, in which control of the volume may include changing volume of each of the plurality of divided sound signals according to the activity amount in each of the plurality of areas.

According to this configuration, for example, when a person in an area is moving, volume of a divided sound signal is made larger than a threshold, and when a person in an area is stationary, volume of a divided sound signal is made smaller than the threshold, so that it is possible to provide a sound environment corresponding to movement of a person in an area.

(14) The sound reproduction method according to any one of (1) to (13) above may further include synchronizing and reproducing a plurality of divided video signals obtained by dividing a predetermined video, and outputting the plurality of divided video signals to a display device that displays a plurality of divided videos converted from the plurality of divided video signals at locations corresponding to a plurality of areas.

According to this configuration, since a plurality of divided videos that are synchronized and reproduced are displayed at locations corresponding to a plurality of areas, the plurality of divided videos overlap each other inside the plurality of areas, and one harmonious video is displayed. Therefore, since people outside the plurality of areas can be guided to the inside of the plurality of areas, the people outside the plurality of areas can be gathered to the inside of the plurality of areas.

The present disclosure can be implemented not only as a sound reproduction method for executing the characteristic processing as described above, but also as a sound reproduction device or the like having a characteristic configuration corresponding to characteristic processing executed by the sound reproduction method. Further, the present disclosure can also be implemented as a computer program that causes a computer to execute characteristic processing included in the sound reproduction method described above. Therefore, an effect similar to the effect in the above sound reproduction method can also be achieved by another aspect described below.

(15) A sound reproduction device according to another aspect of the present disclosure includes a reproduction part that synchronizes and reproduces a plurality of divided sound signals obtained by dividing a predetermined sound, and an output part that outputs the plurality of divided sound signals to a speaker that emits a plurality of divided sounds converted from the plurality of divided sound signals to each of a plurality of areas.

(16) A sound reproduction program according to another aspect of the present disclosure causes a computer to function to synchronize and reproduce a plurality of divided sound signals obtained by dividing a predetermined sound, and output the plurality of divided sound signals to a speaker that emits a plurality of divided sounds converted from the plurality of divided sound signals to each of a plurality of areas.

(17) A non-transitory computer-readable recording medium according to another aspect of the present disclosure records a sound reproduction program, and the sound reproduction program causes a computer to function to synchronize and reproduce a plurality of divided sound signals obtained by dividing a predetermined sound, and output the plurality of divided sound signals to a speaker that emits a plurality of divided sounds converted from the plurality of divided sound signals to each of a plurality of areas.

Hereinafter, embodiments of the present disclosure will be described with reference to the accompanying drawings. Note that each of the embodiments described below illustrates a specific example of the present disclosure. Numerical values, shapes, components, steps, order of steps, and the like of the embodiments below are merely examples, and are not intended to limit the present disclosure. Further, a component not described in an independent claim representing a highest concept among components in the embodiments below is described as an optional component. Further, in all the embodiments, pieces of content can be combined.

### First embodiment

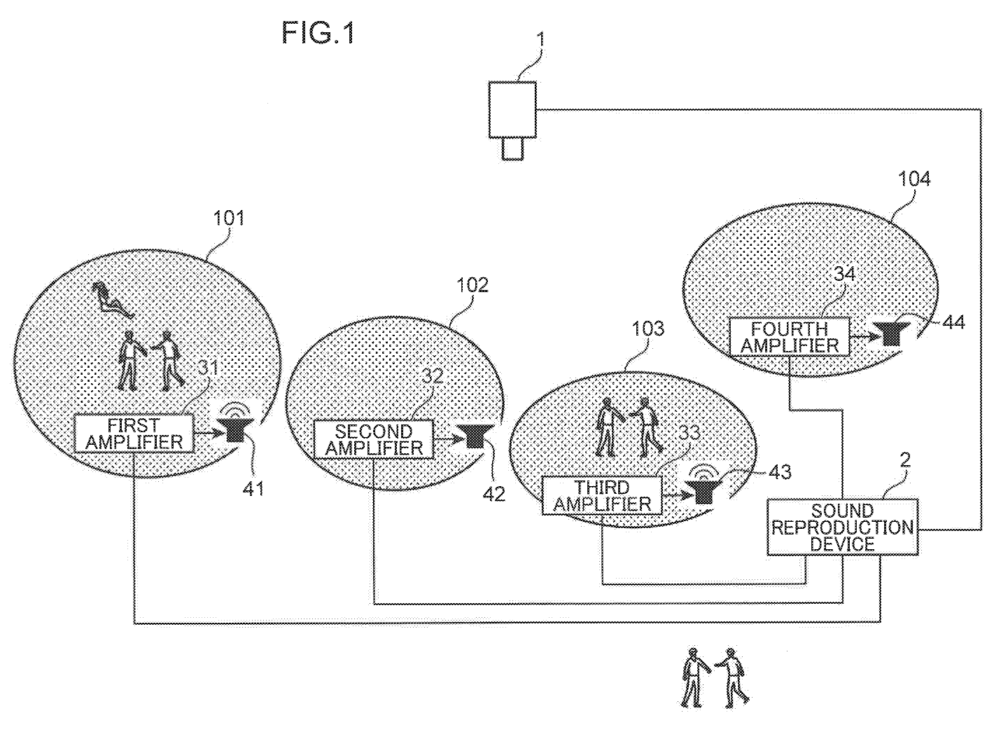

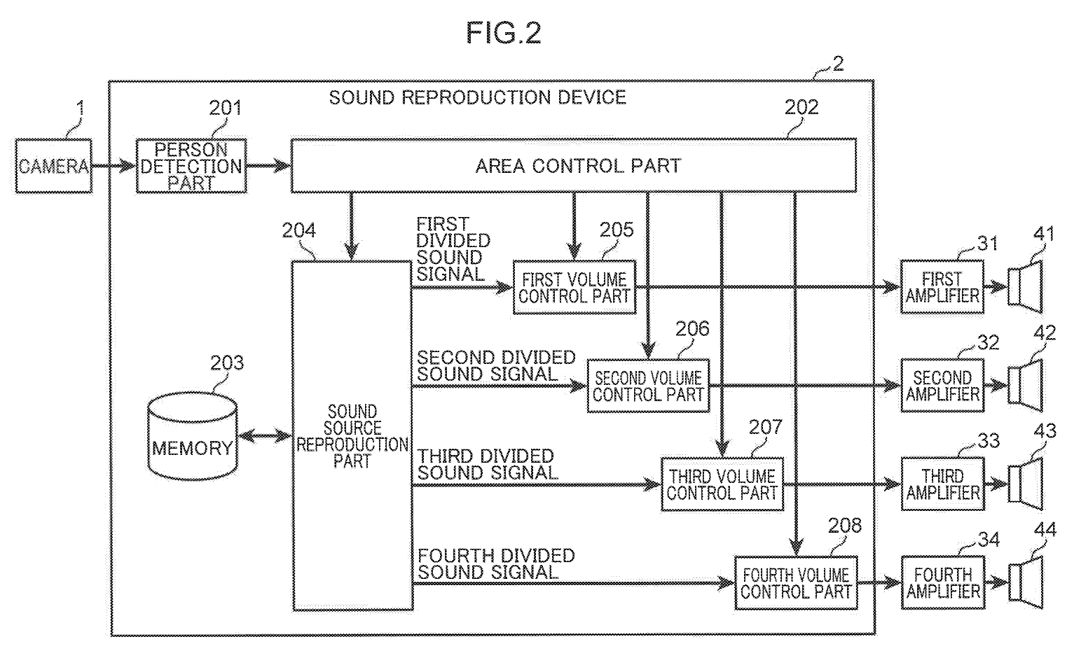

FIG. 1 is a diagram illustrating an overall configuration of a sound reproduction system according to a first embodiment, and FIG. 2 is a block diagram illustrating a configuration of a sound reproduction device 2 according to the first embodiment.

The sound reproduction system includes a camera 1, the sound reproduction device 2, a first amplifier 31, a second amplifier 32, a third amplifier 33, a fourth amplifier 34, a first speaker 41, a second speaker 42, a third speaker 43, and a fourth speaker 44.

The camera 1 captures an image of a plurality of areas obtained by dividing a predetermined space. The camera 1 is a fixed camera such as a monitoring camera, and is disposed at a position where an image of all of a plurality of areas can be captured. The predetermined space is, for example, a public place such as a park where a plurality of people can gather. In the first embodiment, the predetermined space is divided into four areas; however, the present disclosure is not particularly limited to this, and the predetermined space may be divided into two or more areas. In the first embodiment, the camera 1 captures a first area 101, a second area 102, a third area 103, and a fourth area 104. Further, the sound reproduction system may include the single camera 1 or a plurality of the cameras 1. The number of divisions, positions, and sizes of the plurality of areas are determined in advance.

The camera 1 is connected to the sound reproduction device 2 itself or a hub (not illustrated) such as a communication device or a server in a wired or wireless manner so that a captured image can be input to the sound reproduction device 2. The camera 1 may be communicably connected to the sound reproduction device 2 via a network. The camera 1 outputs a captured image to the sound reproduction device 2.

Note that an image captured by the camera 1 may be output in real time, or after the image is once recorded in an external storage device such as a memory or a cloud server, the image may be output from the external storage device.

The sound reproduction device 2 synchronizes and reproduces a plurality of divided sound signals obtained by dividing a predetermined sound, and outputs the plurality of divided sound signals to a speaker that emits a plurality of divided sounds converted from the plurality of divided sound signals to each of a plurality of areas. The sound reproduction device 2 detects the number of people in each of the first area 101 to the fourth area 104 based on an image captured by the camera 1. The sound reproduction device 2 changes volume of each of a first divided sound signal to a fourth divided sound signal according to the number of people in each of the first area 101 to the fourth area 104.

The sound reproduction device 2 includes at least a computer system including, for example, a control program, a processing circuit such as a processor or a logic circuit that executes the control program, and a recording device such as an internal memory or an accessible external memory that stores the control program. Note that the sound reproduction device 2 may be implemented by, for example, hardware implementation by a processing circuit, execution of a software program held in a memory by a processing circuit or distributed from an external server, or a combination of these hardware implementation and software implementation.

The sound reproduction device 2 includes a person detection part 201, an area control part 202, a memory 203, a sound source reproduction part 204, a first volume control part 205, a second volume control part 206, a third volume control part 207, and a fourth volume control part 208.

The person detection part 201 detects the number of people in each of a plurality of areas based on an image captured by the camera 1. The person detection part 201 outputs the number of people in each of a plurality of areas to the area control part 202.

The person detection part 201 inputs an image captured by the camera 1 into a person detection model, and acquires the number of people present in each of a plurality of areas from the person detection model. Regions on an image corresponding to a plurality of areas are determined in advance. The person detection model is created by machine learning using an image of a person as training data. When an image obtained by capturing a plurality of areas is input to the person detection model, the person detection model outputs the number of people present in each of the plurality of areas. Note that the person detection model may be created by machine learning using, as training data, an image obtained by capturing a plurality of areas and the number of people in each of the plurality of areas.

The area control part 202 outputs a reproduction start instruction for starting reproduction of a predetermined sound to the sound source reproduction part 204. The area control part 202 outputs a reproduction start instruction to the sound source reproduction part 204 at predetermined reproduction start time. Further, the area control part 202 may output a reproduction end instruction for ending reproduction of a predetermined sound to the sound source reproduction part 204. The area control part 202 may output a reproduction end instruction to the sound source reproduction part 204 at predetermined reproduction end time.

Note that, in a case where a person is detected in any of a plurality of areas, the area control part 202 may output a reproduction start instruction to the sound source reproduction part 204. Further, in a case where no person is detected in any of a plurality of areas, the area control part 202 may output a reproduction end instruction to the sound source reproduction part 204.

Further, the area control part 202 may select a sound corresponding to a current time period from among a plurality of sounds of different types, and output a reproduction start instruction for starting reproduction of a selected sound to the sound source reproduction part 204. For example, the area control part 202 may select a sound corresponding to a current time period among a first sound corresponding to a time period in the morning (8:00 AM to 12:00 PM), a second sound corresponding to a time period in the afternoon (12:00 PM to 6:00 PM), and a third sound corresponding to a time period in the night (6:00 PM to 10:00 PM). Note that the time period is not limited to the above.

Further, the area control part 202 may select a sound according to the current weather from among a plurality of sounds of different types, and output a reproduction start instruction for starting reproduction of the selected sound to the sound source reproduction part 204. For example, the area control part 202 may acquire weather information from the Internet, determine the current weather such as sunny, cloudy, rainy, or snowy from the acquired weather information, and reproduce a sound according to the determination result.

Further, the area control part 202 may select a sound according to the current season from among a plurality of sounds of different types, and output a reproduction start instruction for starting reproduction of the selected sound to the sound source reproduction part 204. For example, the area control part 202 may acquire the current calendar month, determine the current season such as spring, summer, autumn, or winter from the acquired month, and reproduce a sound according to the determination result. Further, the area control part 202 may acquire information on outside temperature from the Internet, determine the current season from the acquired outside temperature, and reproduce a sound according to the determination result.

The area control part 202 acquires the number of people in each of a plurality of areas from the person detection part 201. The area control part 202 determines volume of each of a plurality of divided sound signals according to the number of people in each of a plurality of areas. The area control part 202 determines volume of the first divided sound signal according to the number of people in the first area 101 and sends an instruction to the first volume control part 205 indicating the determined volume. The area control part 202 determines volume of the second divided sound signal according to the number of people in the second area 102 and sends an instruction to the second volume control part 206 indicating the determined volume. The area control part 202 determines volume of the third divided sound signal according to the number of people in the third area 103 and sends an instruction to the third volume control part 207 indicating the determined volume. The area control part 202 determines volume of the fourth divided sound signal according to the number of people in the fourth area 104 and sends an instruction to the fourth volume control part 208 indicating the determined volume.

In each of a plurality of areas, the area control part 202 determines volume of a divided sound signal to be a predetermined volume in a case where the number of people in the area is equal to or more than a predetermined number of people, and determines volume of a divided sound signal to be zero in a case where the number of people in the area is smaller than the predetermined number of people. The predetermined number of people is, for example, one, and the predetermined volume is, for example, maximum volume. For example, in each of a plurality of areas, the area control part 202 may determine volume of a divided sound signal to be maximum volume in a case where the number of people in the area is one or more, and may determine volume of a divided sound signal to be zero in a case where the number of people in the area is less than one, that is, in a case where the number of people in the area is zero.

Note that the predetermined number of people is not limited to one, and may be two or more, such as three or five. Further, the predetermined volume is not limited to maximum volume, and may be 50% or 80% of maximum volume, and only needs to be larger than 0. Further, the predetermined volume is preferably volume at which a divided sound can be heard from another area. By the above, a person in an area can hear a divided sound emitted in another area, and can hear a predetermined sound in which a plurality of divided sounds overlap in the area.

The predetermined sound is, for example, a series of musical pieces by performance of a plurality of musical instruments. Note that the predetermined sound is not limited to music as long as the predetermined sound is a series of audio contents, and, for example, the predetermined sound may be a series of natural sounds including a plurality of sounds such as a wind sound, a sound of running water, a chirping sound of an insect, or a chirping sound of a bird. In addition to the above, the predetermined sound may be a series of sounds in a radio program, a talk show, or the like including voices of a plurality of people or a plurality of sounds.

The memory 203 stores in advance a plurality of divided sound signals obtained by dividing the predetermined sound. The memory 203 stores in advance the first divided sound signal, the second divided sound signal, the third divided sound signal, and the fourth divided sound signal. Note that the memory 203 may store a plurality of sounds in advance. The number of a plurality of divided sound signals may be the same as or different from the number of a plurality of areas. Further, in which area each of a plurality of divided sounds is emitted is determined in advance.

Furthermore, the predetermined sound may be divided according to frequency.

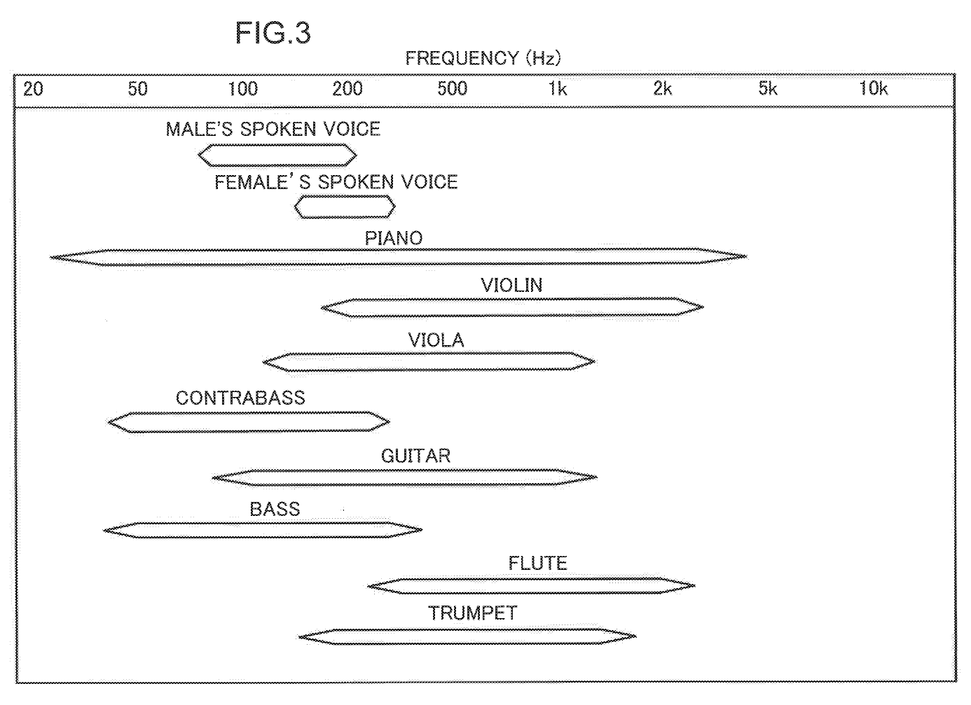

FIG. 3 is a diagram illustrating voice of a person and a frequency band of a musical instrument. For example, the predetermined sound may be divided into the first divided sound signal at a frequency of 50 Hz or less, the second divided sound signal at a frequency between 50 Hz and 500 Hz, the third divided sound signal at a frequency between 500 Hz and 1 kHz, and the fourth divided sound signal at a frequency of 1 kHz or more.

Further, the predetermined sound may be divided according to a type of musical instrument to be played. For example, the predetermined sound may be divided into the first divided sound signal representing a drum sound, the second divided sound signal representing a bass sound, the third divided sound signal representing a keyboard sound, and the fourth divided sound signal representing a guitar sound.

Further, the predetermined sound may be divided according to a performance part of music to be reproduced. For example, the predetermined sound may be divided into the first divided sound signal representing a melody part playing a main melody, the second divided sound signal representing a harmony part playing a chord or a secondary melody for the melody part, the third divided sound signal representing a rhythm part responsible for a rhythm of music, and the fourth divided sound signal representing a bass part responsible for a low frequency range.

Further, the predetermined sound may be divided according to a plurality of elements constituting the predetermined sound. For example, in a case where the predetermined sound is a series of natural sounds, the predetermined sound may be divided into the first divided sound signal representing a wind sound, the second divided sound signal representing a sound of running water, the third divided sound signal representing a chirping sound of an insect, and the fourth divided sound signal representing a chirping sound of a bird. Further, for example, in a case where the predetermined sound is a series of sounds in a talk show or the like, the predetermined sound may be divided into the first divided sound signal representing voice of a first person, the second divided sound signal representing voice of a second person, the third divided sound signal representing a background sound, and the fourth divided sound signal representing a sound effect.

The sound source reproduction part 204 synchronizes and reproduces a plurality of divided sound signals obtained by dividing a predetermined sound. The sound source reproduction part 204 is an example of a reproduction part. The sound source reproduction part 204 reads a plurality of divided sound signals from the memory 203. When a reproduction start instruction is input from the area control part 202, the sound source reproduction part 204 starts reproduction of a plurality of divided sound signals obtained by dividing the predetermined sound. Further, when a reproduction end instruction is input from the area control part 202, the sound source reproduction part 204 ends reproduction of a plurality of divided sound signals obtained by dividing the predetermined sound.

The sound source reproduction part 204 synchronizes and reproduces all of the first divided sound signal to the fourth divided sound signal regardless of whether or not there is a person in each of the first area 101 to the fourth area 104.

The sound source reproduction part 204 outputs the first divided sound signal to the first volume control part 205, outputs the second divided sound signal to the second volume control part 206, outputs the third divided sound signal to the third volume control part 207, and outputs the fourth divided sound signal to the fourth volume control part 208.

The first volume control part 205 to the fourth volume control part 208 output a plurality of divided sound signals reproduced by the sound source reproduction part 204 to a speaker that emits a plurality of divided sounds converted from a plurality of divided sound signals to each of a plurality of areas. The first volume control part 205 to the fourth volume control part 208 are examples of an output part. Further, the first volume control part 205 to the fourth volume control part 208 control volume of each of a plurality of divided sound signals according to the number of people in each of a plurality of areas.

The first volume control part 205 controls volume of the first divided sound signal according to the number of people in the first area 101. The first volume control part 205 sets volume of the first divided sound signal input from the sound source reproduction part 204 to volume instructed by the area control part 202.

The second volume control part 206 controls volume of the second divided sound signal according to the number of people in the second area 102. The second volume control part 206 sets volume of the second divided sound signal input from the sound source reproduction part 204 to volume instructed by the area control part 202.

The third volume control part 207 controls volume of the third divided sound signal according to the number of people in the third area 103. The third volume control part 207 sets volume of the third divided sound signal input from the sound source reproduction part 204 to volume instructed by the area control part 202.

The fourth volume control part 208 controls volume of the fourth divided sound signal according to the number of people in the fourth area 104. The fourth volume control part 208 sets volume of the fourth divided sound signal input from the sound source reproduction part 204 to volume instructed by the area control part 202.

The first volume control part 205 to the fourth volume control part 208 output a plurality of divided sound signals (the first divided sound signal to the fourth divided sound signal) reproduced by the sound source reproduction part 204 to a plurality of speakers (the first speaker 41 to the fourth speaker 44) installed in a plurality of areas (the first area 101 to the fourth area 104), respectively. The first volume control part 205 outputs the first divided sound signal with set volume to the first speaker 41 via the first amplifier 31. The second volume control part 206 outputs the second divided sound signal with set volume to the second speaker 42 via the second amplifier 32. The third volume control part 207 outputs the third divided sound signal with set volume to the third speaker 43 via the third amplifier 33. The fourth volume control part 208 outputs the fourth divided sound signal with set volume to the fourth speaker 44 via the fourth amplifier 34.

The sound reproduction device 2 is connected to a plurality of amplifiers themselves or a hub (not illustrated) such as a communication device or a server in a wired or wireless manner so that a plurality of divided sound signals can be input to a plurality of amplifiers (the first amplifier 31 to the fourth amplifier 34). The sound reproduction device 2 may be communicably connected to each of a plurality of amplifiers (the first amplifier 31 to the fourth amplifier 34) via a network. The sound reproduction device 2 outputs the first divided sound signal to the first amplifier 31, outputs the second divided sound signal to the second amplifier 32, outputs the third divided sound signal to the third amplifier 33, and outputs the fourth divided sound signal to the fourth amplifier 34.

The first amplifier 31 amplifies the first divided sound signal input from the first volume control part 205 of the sound reproduction device 2.

The second amplifier 32 amplifies the second divided sound signal input from the second volume control part 206 of the sound reproduction device 2.

The third amplifier 33 amplifies the third divided sound signal input from the third volume control part 207 of the sound reproduction device 2.

The fourth amplifier 34 amplifies the fourth divided sound signal input from the fourth volume control part 208 of the sound reproduction device 2.

Note that the first amplifier 31 to the fourth amplifier 34 may be disposed in each area or may be disposed outside each area.

The first speaker 41 is disposed in the first area 101, converts the first divided sound signal amplified by the first amplifier 31 into the first divided sound, and emits the first divided sound into the first area 101. In a case where volume of the first divided sound signal is set to a predetermined volume by the first volume control part 205, the first speaker 41 emits the first divided sound at the predetermined volume. In a case where volume of the first divided sound signal is set to zero by the first volume control part 205, the first speaker 41 does not emit the first divided sound.

The second speaker 42 is disposed in the second area 102, converts the second divided sound signal amplified by the second amplifier 32 into the second divided sound, and emits the second divided sound into the second area 102. In a case where volume of the second divided sound signal is set to a predetermined volume by the second volume control part 206, the second speaker 42 emits the second divided sound at the predetermined volume. In a case where volume of the second divided sound signal is set to zero by the second volume control part 206, the second speaker 42 does not emit the second divided sound.

The third speaker 43 is disposed in the third area 103, converts the third divided sound signal amplified by the third amplifier 33 into the third divided sound, and emits the third divided sound into the third area 103. In a case where volume of the third divided sound signal is set to a predetermined volume by the third volume control part 207, the third speaker 43 emits the third divided sound at the predetermined volume. In a case where volume of the third divided sound signal is set to zero by the third volume control part 207, the third speaker 43 does not emit the third divided sound.

The fourth speaker 44 is disposed in the fourth area 104, converts the fourth divided sound signal amplified by the fourth amplifier 34 into the fourth divided sound, and emits the fourth divided sound into the fourth area 104. In a case where volume of the fourth divided sound signal is set to a predetermined volume by the fourth volume control part 208, the fourth speaker 44 emits the fourth divided sound at the predetermined volume. In a case where volume of the fourth divided sound signal is set to zero by the fourth volume control part 208, the fourth speaker 44 does not emit the fourth divided sound.

Next, sound reproduction processing by the sound reproduction device 2 according to the first embodiment of the present disclosure will be described.

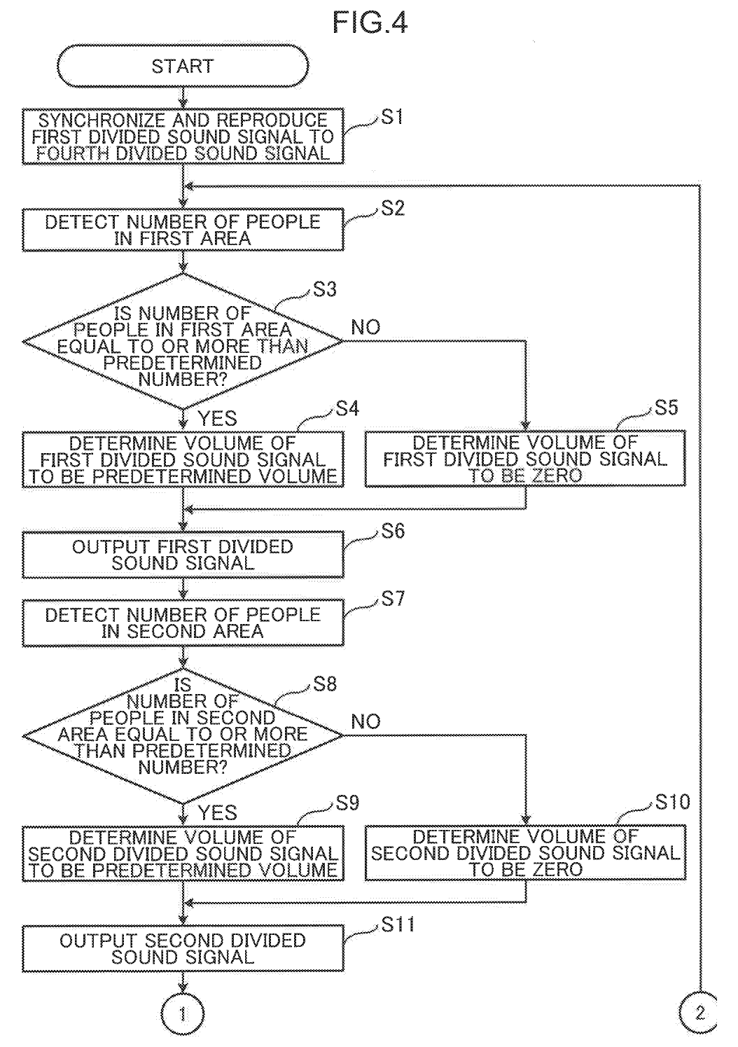

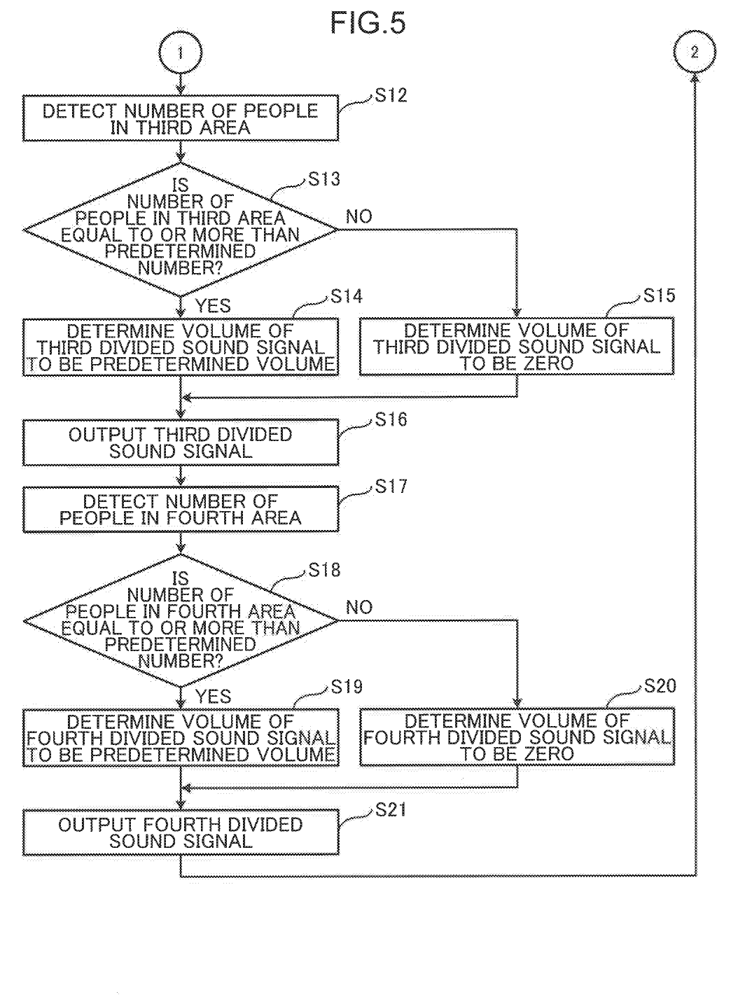

FIG. 4 is a first flowchart for explaining sound reproduction processing by the sound reproduction device 2 in the first embodiment of the present disclosure, and FIG. 5 is a second flowchart for explaining sound reproduction processing by the sound reproduction device 2 in the first embodiment of the present disclosure.

First, in Step S1, the sound source reproduction part 204 synchronizes and reproduces the first divided sound signal to the fourth divided sound signal obtained by dividing a predetermined sound. At this time, the area control part 202 outputs a reproduction start instruction for starting reproduction of a predetermined sound to the sound source reproduction part 204. When the reproduction start instruction is input from the area control part 202, the sound source reproduction part 204 reads the first divided sound signal to the fourth divided sound signal from the memory 203 and synchronizes and reproduces the read first divided sound signal to fourth divided sound signal. The sound source reproduction part 204 outputs the reproduced first divided sound signal to fourth divided sound signal to the first volume control part 205 to the fourth volume control part 208, respectively.

Next, in Step S2, the person detection part 201 detects the number of people in the first area 101 based on an image captured by the camera 1. The person detection part 201 outputs the detected number of people in the first area 101 to the area control part 202. The area control part 202 acquires the number of people in the first area 101 from the person detection part 201.

Next, in Step S3, the area control part 202 determines whether or not the number of people in the first area 101 is equal to or more than a predetermined number of people. The predetermined number of people is, for example, one.

Here, in a case where it is determined that the number of people in the first area 101 is equal to or more than the predetermined number of people (YES in Step S3), the area control part 202 determines volume of the first divided sound signal to be a predetermined volume in Step S4. The predetermined volume is, for example, maximum volume. The area control part 202 sends an instruction to the first volume control part 205 indicating volume of the first divided sound signal determined to be the predetermined volume. The first volume control part 205 sets volume of the first divided sound signal to the predetermined volume based on the instruction from the area control part 202.

On the other hand, in a case where it is determined that the number of people in the first area 101 is not equal to or more than the predetermined number of people, that is, in a case where it is determined that the number of people in the first area 101 is smaller than the predetermined number of people (NO in Step S3), the area control part 202 determines volume of the first divided sound signal to be zero in Step S5. The area control part 202 sends an instruction to the first volume control part 205 indicating volume of the first divided sound signal determined to be zero. The first volume control part 205 sets volume of the first divided sound signal to zero based on the instruction from the area control part 202.

Next, in Step S6, the first volume control part 205 outputs the first divided sound signal with the set volume to the first amplifier 31. The first amplifier 31 amplifies the first divided sound signal and outputs the amplified first divided sound signal to the first speaker 41. The first speaker 41 converts the first divided sound signal into a first divided sound, and emits, into the first area 101, the first divided sound with the volume set by the first volume control part 205.

By the above, when the number of people in the first area 101 is equal to or more than the predetermined number of people, the first divided sound at the predetermined volume is output from the first speaker 41, and when the number of people in the first area 101 is smaller than the predetermined number of people, the first divided sound is not output from the first speaker 41.

Next, in Step S7, the person detection part 201 detects the number of people in the second area 102 based on an image captured by the camera 1. The person detection part 201 outputs the detected number of people in the second area 102 to the area control part 202. The area control part 202 acquires the number of people in the second area 102 from the person detection part 201.

Next, in Step S8, the area control part 202 determines whether the number of people in the second area 102 is equal to or more than a predetermined number of people. The predetermined number of people is, for example, one.

Here, in a case where it is determined that the number of people in the second area 102 is equal to or more than the predetermined number of people (YES in Step S8), the area control part 202 determines volume of the second divided sound signal to be a predetermined volume in Step S9. The predetermined volume is, for example, maximum volume. The area control part 202 sends an instruction to the second volume control part 206 indicating volume of the second divided sound signal determined to be the predetermined volume. The second volume control part 206 sets volume of the second divided sound signal to the predetermined volume based on the instruction from the area control part 202.

On the other hand, in a case where it is determined that the number of people in the second area 102 is not equal to or more than the predetermined number of people, that is, in a case where it is determined that the number of people in the second area 102 is smaller than the predetermined number of people (NO in Step S8), the area control part 202 determines volume of the second divided sound signal to be zero in Step S10. The area control part 202 sends an instruction to the second volume control part 206 indicating volume of the second divided sound signal determined to be zero. The second volume control part 206 sets volume of the second divided sound signal to zero based on the instruction from the area control part 202.

Next, in Step S11, the second volume control part 206 outputs the second divided sound signal with the set volume to the second amplifier 32. The second amplifier 32 amplifies the second divided sound signal and outputs the amplified second divided sound signal to the second speaker 42. The second speaker 42 converts the second divided sound signal into a second divided sound, and emits, into the second area 102, the second divided sound with the volume set by the second volume control part 206.

By the above, when the number of people in the second area 102 is equal to or more than the predetermined number of people, the second divided sound at the predetermined volume is output from the second speaker 42, and when the number of people in the second area 102 is smaller than the predetermined number of people, the second divided sound is not output from the second speaker 42.

Next, in Step S12, the person detection part 201 detects the number of people in the third area 103 based on an image captured by the camera 1. The person detection part 201 outputs the detected number of people in the third area 103 to the area control part 202. The area control part 202 acquires the number of people in the third area 103 from the person detection part 201.

Next, in Step S13, the area control part 202 determines whether or not the number of people in the third area 103 is equal to or more than a predetermined number of people. The predetermined number of people is, for example, one.

Here, in a case where it is determined that the number of people in the third area 103 is equal to or more than the predetermined number of people (YES in Step S13), the area control part 202 determines volume of the third divided sound signal to be a predetermined volume in Step S14. The predetermined volume is, for example, maximum volume. The area control part 202 sends an instruction to the third volume control part 207 indicating volume of the third divided sound signal determined to be the predetermined volume. The third volume control part 207 sets volume of the third divided sound signal to the predetermined volume based on the instruction from the area control part 202.

On the other hand, in a case where it is determined that the number of people in the third area 103 is not equal to or more than the predetermined number of people, that is, in a case where it is determined that the number of people in the third area 103 is smaller than the predetermined number of people (NO in Step S13), the area control part 202 determines volume of the third divided sound signal to be zero in Step S15. The area control part 202 sends an instruction to the third volume control part 207 indicating volume of the third divided sound signal determined to be zero. The third volume control part 207 sets volume of the third divided sound signal to zero based on the instruction from the area control part 202.

Next, in Step S16, the third volume control part 207 outputs the third divided sound signal with the set volume to the third amplifier 33. The third amplifier 33 amplifies the third divided sound signal and outputs the amplified third divided sound signal to the third speaker 43. The third speaker 43 converts the third divided sound signal into a third divided sound, and emits, into the third area 103, the third divided sound with the volume set by the third volume control part 207.

By the above, when the number of people in the third area 103 is equal to or more than the predetermined number of people, the third divided sound at the predetermined volume is output from the third speaker 43, and when the number of people in the third area 103 is smaller than the predetermined number of people, the third divided sound is not output from the third speaker 43.

Next, in Step S17, the person detection part 201 detects the number of people in the fourth area 104 based on an image captured by the camera 1. The person detection part 201 outputs the detected number of people in the fourth area 104 to the area control part 202. The area control part 202 acquires the number of people in the fourth area 104 from the person detection part 201.

Next, in Step S18, the area control part 202 determines whether or not the number of people in the fourth area 104 is equal to or more than a predetermined number of people. The predetermined number of people is, for example, one.

Here, in a case where it is determined that the number of people in the fourth area 104 is equal to or more than the predetermined number of people (YES in Step S18), the area control part 202 determines volume of the fourth divided sound signal to be a predetermined volume in Step S19. The predetermined volume is, for example, maximum volume. The area control part 202 sends an instruction to the fourth volume control part 208 indicating volume of the fourth divided sound signal determined to be the predetermined volume. The fourth volume control part 208 sets volume of the fourth divided sound signal to the predetermined volume based on the instruction from the area control part 202.

On the other hand, in a case where it is determined that the number of people in the fourth area 104 is not equal to or more than the predetermined number of people, that is, in a case where it is determined that the number of people in the fourth area 104 is smaller than the predetermined number of people (NO in Step S18), the area control part 202 determines volume of the fourth divided sound signal to be zero in Step S20. The area control part 202 sends an instruction to the fourth volume control part 208 indicating volume of the fourth divided sound signal determined to be zero. The fourth volume control part 208 sets volume of the fourth divided sound signal to zero based on the instruction from the area control part 202.

Next, in Step S21, the fourth volume control part 208 outputs the fourth divided sound signal with the set volume to the fourth amplifier 34. The fourth amplifier 34 amplifies the fourth divided sound signal and outputs the amplified fourth divided sound signal to the fourth speaker 44. The fourth speaker 44 converts the fourth divided sound signal into a fourth divided sound, and emits, into the fourth area 104, the fourth divided sound with the volume set by the fourth volume control part 208.

By the above, when the number of people in the fourth area 104 is equal to or more than the predetermined number of people, the fourth divided sound at the predetermined volume is output from the fourth speaker 44, and when the number of people in the fourth area 104 is smaller than the predetermined number of people, the fourth divided sound is not output from the fourth speaker 44.

As described above, when people gather in each of a plurality of areas, a plurality of divided sounds overlap each other, and one predetermined harmonious sound is output. For this reason, a person outside a plurality of areas who hears a plurality of divided sounds overlapping each other wants to go to the inside of the plurality of areas, and people can be gathered in the plurality of areas.

Further, in a case where there is a person in an area, since a divided sound is emitted into the area, a sound outside the area is masked by the divided sound, and a person in the area can have a conversation without being disturbed by surrounding sound.

Furthermore, in a case where there are people in a plurality of areas, since divided sounds are emitted into the areas where people are present, a person in an area hears, in addition to a divided sound emitted into the area, a divided sound emitted into another surrounding area in an overlapping manner, and a plurality of the overlapping divided sounds form a harmonious sound. For this reason, it is possible to provide a sound environment achieving the above-described masking effect for each area without causing discomfort to a person in each area.

Note that, in the first embodiment, the number of people in a plurality of areas is detected based on an image captured by the camera 1, but the present disclosure is not particularly limited to this, and a sensor other than the camera 1 may be used. The sensor may detect how many people are in each of a plurality of areas. For example, the sensor may be a human detection sensor that detects a person by using an infrared ray. Further, the sensor may be a seating detection sensor or a pressure-sensitive sensor provided in a chair in a plurality of areas, and the number of people may be detected by the seating detection sensor or the pressure-sensitive sensor. As described above, by not using a camera as the sensor, it is possible to protect privacy of a person in each area.

Further, in the first embodiment, a plurality of areas do not overlap each other, but parts of a plurality of areas may overlap each other. For example, a part of the first area 101 and a part of the second area 102 may overlap each other. In a case where there is a person in a portion where a part of the first area 101 and a part of the second area 102 overlap, the first divided sound may be emitted to the first area 101 and the second divided sound may be emitted to the second area 102.

Further, in a first modification example of the first embodiment, the area control part 202 may determine volume of each divided sound signal according to the number of people in each area.

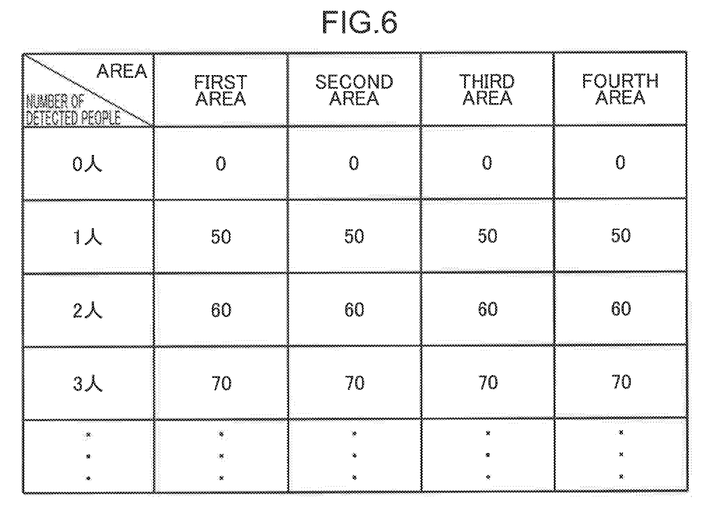

FIG. 6 is a diagram illustrating an example of a table in which the number of people detected in an area is associated with volume of a divided sound emitted into the area in the first modification example of the first embodiment. Note that, in FIG. 6, volume represents a ratio to maximum volume (100%).

For example, the area control part 202 may set volume of the first divided sound emitted into the first area 101 to zero in a case where the number of people in the first area 101 is 0, set volume of the first divided sound emitted into the first area 101 to 50% of maximum volume in a case where the number of people in the first area 101 is 1, set volume of the first divided sound emitted into the first area 101 to 60% of maximum volume in a case where the number of people in the first area 101 is 2, and set volume of the first divided sound emitted into the first area 101 to 70% of maximum volume in a case where the number of people in the first area 101 is 3.

Further, the area control part 202 may change a threshold of the number of detected people for changing volume according to the number of people in all of a plurality of areas. In a case where the number of people in all of a plurality of areas increases, the area control part 202 may increase the threshold of the number of detected people for changing volume. In a case where the total number of people in all of a plurality of areas is 10, the area control part 202 may determine volume of the first divided sound signal to be 0 when the number of people in the first area 101 is 0, determine the volume of the first divided sound signal to be 50% of maximum volume when the number of people in the first area 101 is 1, determine the volume of the first divided sound signal to be 60% of the maximum volume when the number of people in the first area 101 is 2, determine the volume of the first divided sound signal to be 70% of the maximum volume when the number of people in the first area 101 is 3, determine the volume of the first divided sound signal to be 80% of the maximum volume when the number of people in the first area 101 is 4, determine the volume of the first divided sound signal to be 90% of the maximum volume when the number of people in the first area 101 is 5, and determine the volume of the first divided sound signal to be 100% of the maximum volume when the number of people in the first area 101 is 6 or more.

Further, in a case where the total number of people in all of a plurality of areas is 100, the area control part 202 may determine volume of the first divided sound signal to be 0 when the number of people in the first area 101 is 0, determine the volume of the first divided sound signal to be 50% of maximum volume when the number of people in the first area 101 is 1 or more and less than 5, determine the volume of the first divided sound signal to be 60% of the maximum volume when the number of people in the first area 101 is 5 or more and less than 10, determine the volume of the first divided sound signal to be 70% of the maximum volume when the number of people in the first area 101 is 10 or more and less than 15, determine the volume of the first divided sound signal to be 80% of the maximum volume when the number of people in the first area 101 is 15 or more and less than 20, determine the volume of the first divided sound signal to be 90% of the maximum volume when the number of people in the first area 101 is 20 or more and less than 25, and determine the volume of the first divided sound signal to be 100% of the maximum volume when the number of people in the first area 101 is 25 or more.

Further, in a second modification example of the first embodiment, the area control part 202 may select one sound from a plurality of sounds of different types (genres), and instruct the sound source reproduction part 204 to reproduce a plurality of divided sound signals obtained by dividing the selected one sound.

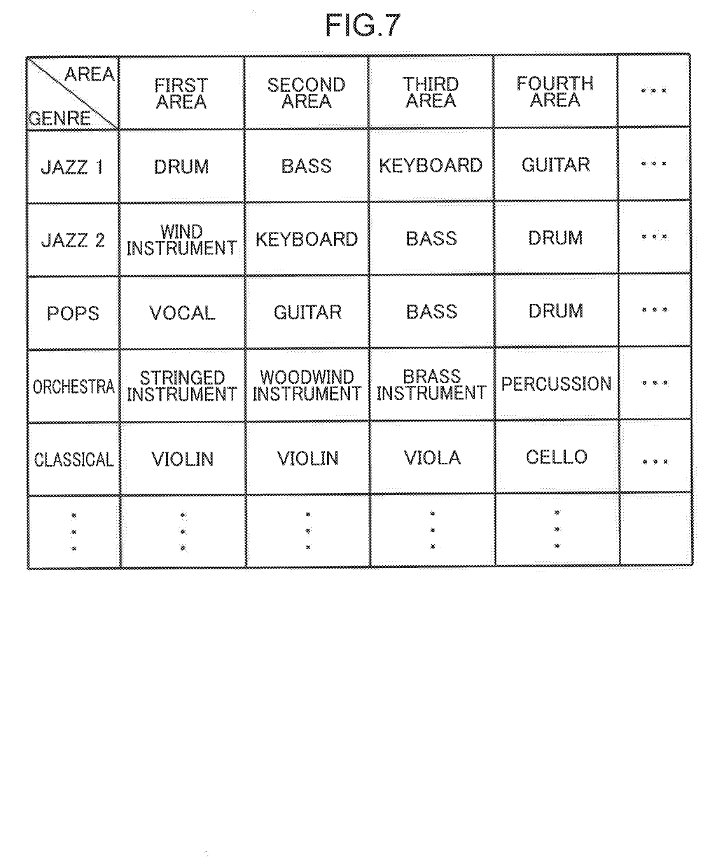

FIG. 7 is a diagram illustrating an example of a table in which a plurality of sounds of different types (genres) are associated with types of divided sounds to be emitted into each area in the second modification example of the first embodiment.

For example, types (genres) of sound include jazz, pop, orchestral, and classical. The sound reproduction device 2 may receive selection of one sound by an administrator from among a plurality of sounds of different types (genres). Then, the area control part 202 may output a reproduction start instruction for starting reproduction of the sound selected by the administrator to the sound source reproduction part 204. Further, the area control part 202 may select a sound corresponding to a current time period from among a plurality of sounds of different types (genres), and output a reproduction start instruction for starting reproduction of the selected sound to the sound source reproduction part 204.

Further, each of the plurality of sounds may be divided according to a type of musical instrument to be played. For example, in a case where a sound of “Jazz 1” is selected, the first divided sound representing a drum sound may be emitted to the first area 101, the second divided sound representing a bass sound may be emitted to the second area 102, the third divided sound representing a keyboard sound may be emitted to the third area 103, and the fourth divided sound representing a guitar sound may be emitted to the fourth area 104.

Further, one divided sound signal may include sounds of a plurality of musical instruments. For example, the first divided sound signal may include a bass sound and a guitar sound.

Further, in the first embodiment, the sound source reproduction part 204 may continuously reproduce a background sound signal different from a plurality of divided sound signals. The sound source reproduction part 204 may output the background sound signal to the first volume control part 205 to the fourth volume control part 208. The first volume control part 205 to the fourth volume control part 208 may set volume of the background sound signal to volume of 50% of maximum volume and output the background sound signal to the first amplifier 31 to the fourth amplifier 34. The first speaker 41 to the fourth speaker 44 may continuously emit the background sound, and may emit the first to fourth divided sounds in a manner overlapping the background sound.

Note that the background sound may be, for example, a natural sound such as a wind sound, a sound of running water, a chirping sound of an insect, or a chirping sound of a bird. A natural sound has an effect of calming the mind of a person, and by continuously reproducing a natural sound in a plurality of areas, it is possible to gather people in the plurality of areas.

Further, the background sound may be, for example, a sound of a musical instrument that covers a frequency band of human voice. As illustrated in FIG. 3, a frequency band of a piano sound overlaps a frequency band of human voice, and the sound source reproduction part 204 may continuously reproduce a piano sound signal as the background sound signal separately from a plurality of divided sound signals. As a sound signal of a musical instrument that covers a frequency band of human voice is continuously reproduced, human voice in another area can be masked.

Further, the area control part 202 may change the predetermined sound according to the total number of people in all of a plurality of areas. For example, in a case where the total number of people in all of a plurality of areas is smaller than a predetermined number of people, the area control part 202 may select music with a slow tempo where Beats Per Minute (BPM) is smaller than a threshold, and in a case where the total number of people in all of a plurality of areas is equal to or more than the predetermined number of people, the area control part 202 may select music with a fast tempo where BPM is equal to or more than the threshold.

Further, the sound reproduction system may further include a sensor that measures volume of voice of a person in each of a plurality of areas. Then, the area control part 202 of the sound reproduction device 2 may acquire volume of voice of a person in each of a plurality of areas from the sensor. The area control part 202 may change volume of each of a plurality of divided sound signals according to volume of voice in each of the plurality of areas. For example, the area control part 202 may increase volume of a divided sound signal as volume of voice in an area increases.

Further, the area control part 202 may acquire volume of voice of a person in each of a plurality of areas from the sensor, and calculate total volume of voice in all of the plurality of areas. The area control part 202 may change the predetermined sound according to the total volume of voice in all of the plurality of areas. For example, in a case where the total volume of voice in all of a plurality of areas is smaller than a threshold, the area control part 202 may select music with a slow tempo where BPM is smaller than a threshold, and in a case where the total volume of voice in all of a plurality of areas is equal to or more than the threshold, the area control part 202 may select music with a fast tempo where BPM is equal to or more than the threshold.

Further, the sound reproduction system may further include a sensor that measures an activity amount of a person in each of a plurality of areas. The activity amount indicates, for example, whether or not a person is moving. Then, the area control part 202 of the sound reproduction device 2 may acquire the activity amount of a person in each of a plurality of areas from the sensor. The area control part 202 may change volume of each of a plurality of divided sound signals according to the activity amount of each of the plurality of areas. For example, the area control part 202 may increase volume of a divided sound signal as the activity amount in an area increases. The area control part 202 may set volume of a divided sound signal to be larger than a threshold when a person in an area is moving, and may set volume of a divided sound signal to be smaller than the threshold when a person in an area is stationary.

Further, the area control part 202 may acquire an activity amount of a person in each of a plurality of areas from the sensor, and calculate a total activity amount in all of the plurality of areas. The area control part 202 may change the predetermined sound according to the total activity amount in all of the plurality of areas. For example, in a case where the total activity amount in all of a plurality of areas is smaller than a threshold, the area control part 202 may select music with a slow tempo where BPM is smaller than a threshold, and in a case where the total activity amount in all of a plurality of areas is equal to or more than the threshold, the area control part 202 may select music with a fast tempo where BPM is equal to or more than the threshold. In a case where the total number of moving people in all of a plurality of areas is smaller than a predetermined number of people, the area control part 202 may select music with a slow tempo where BPM is smaller than a threshold, and in a case where the total number of moving people in all of a plurality of areas is equal to or more than the predetermined number of people, the area control part 202 may select music with a fast tempo where BPM is equal to or more than the threshold.

### Second embodiment

The sound reproduction system according to the first embodiment includes the first speaker 41 to the fourth speaker 44 that emit the first divided sound to the fourth divided sound toward the inside of the first area 101 to the fourth area 104; however, the sound reproduction system according to a second embodiment includes the first speaker 41 to the fourth speaker 44 that emit the first divided sound to the fourth divided sound toward the inside of the first area 101 to the fourth area 104, and a fifth speaker 45 to an eighth speaker 48 that emit the first divided sound to the fourth divided sound toward the outside of the first area 101 to the fourth area 104.

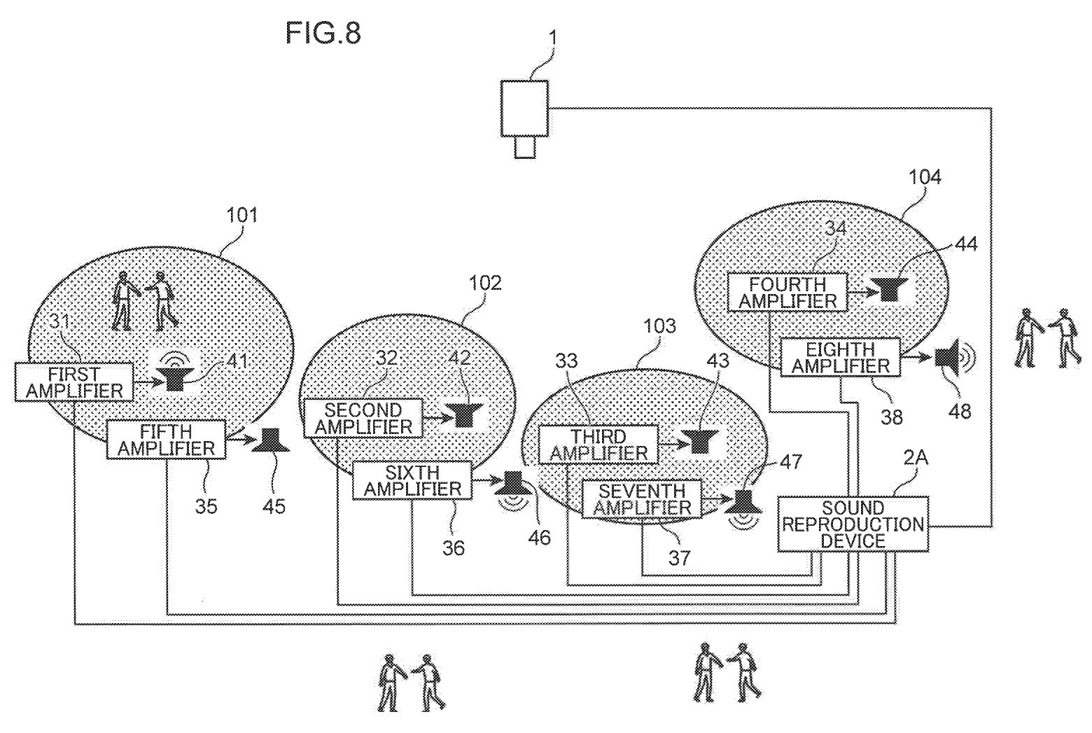

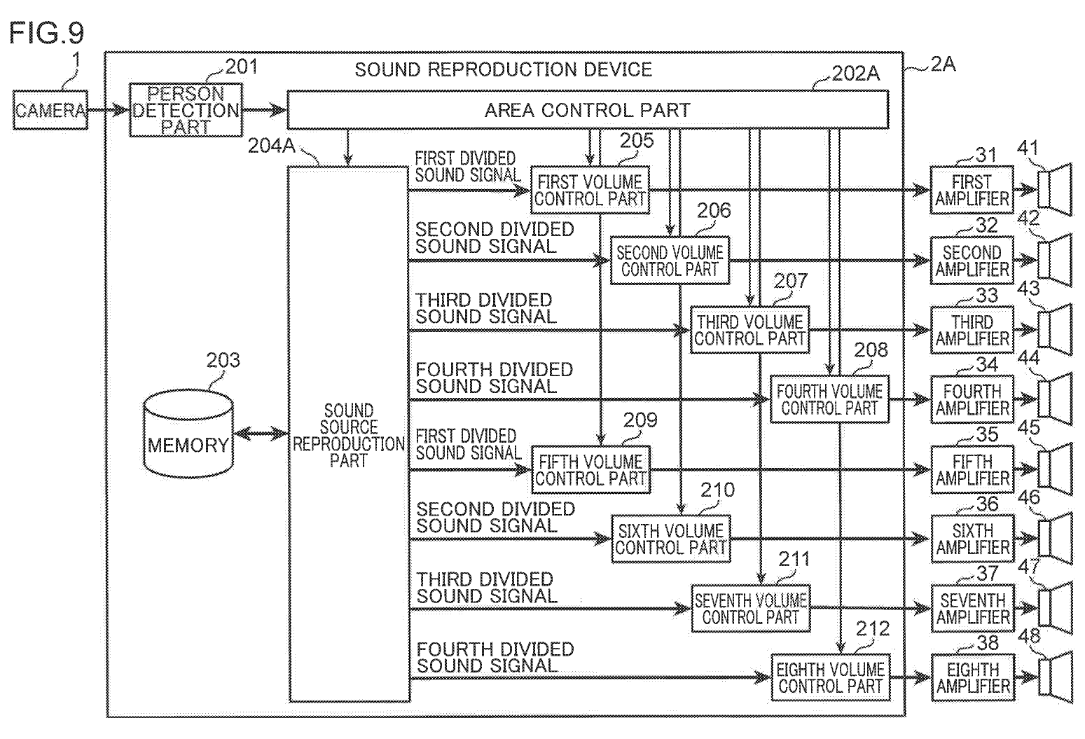

FIG. 8 is a diagram illustrating an overall configuration of the sound reproduction system according to the second embodiment, and FIG. 9 is a block diagram illustrating a configuration of a sound reproduction device 2A according to the second embodiment.

The sound reproduction system according to the second embodiment includes the camera 1, the sound reproduction device 2A, the first amplifier 31, the second amplifier 32, the third amplifier 33, the fourth amplifier 34, a fifth amplifier 35, a sixth amplifier 36, a seventh amplifier 37, an eighth amplifier 38, the first speaker 41, the second speaker 42, the third speaker 43, the fourth speaker 44, the fifth speaker 45, the sixth speaker 46, the seventh speaker 47, and the eighth speaker 48. Note that, in the second embodiment, the same configuration as that in the first embodiment will be denoted by the same reference sign as that in the first embodiment, and will be omitted from description.

The sound reproduction device 2A includes at least a computer system including, for example, a control program, a processing circuit such as a processor or a logic circuit that executes the control program, and a recording device such as an internal memory or an accessible external memory that stores the control program. Note that the sound reproduction device 2A may be implemented by, for example, hardware implementation by a processing circuit, execution of a software program held in a memory by a processing circuit or distributed from an external server, or a combination of these hardware implementation and software implementations.

The sound reproduction device 2A includes the person detection part 201, an area control part 202A, the memory 203, a sound source reproduction part 204A, the first volume control part 205, the second volume control part 206, the third volume control part 207, the fourth volume control part 208, a fifth volume control part 209, a sixth volume control part 210, a seventh volume control part 211, and an eighth volume control part 212.

The first speaker 41 emits a first divided sound into the first area 101, the second speaker 42 emits a second divided sound into the second area 102, the third speaker 43 emits a third divided sound into the third area 103, and the fourth speaker 44 emits a fourth divided sound into the fourth area 104.

The fifth speaker 45 emits the first divided sound toward the outside of the first area 101, the sixth speaker 46 emits the second divided sound toward the outside of the second area 102, the seventh speaker 47 emits the third divided sound toward the outside of the third area 103, and the eighth speaker 48 emits the fourth divided sound toward the outside of the fourth area 104.

In each of a plurality of areas, the area control part 202A causes a divided sound to be emitted toward the outside of an area in a case where there is no person in the area, and causes a divided sound to be emitted toward the inside of an area in a case where there is a person in the area.

In a case where there is no person in the first area 101, the area control part 202A sends an instruction to the first volume control part 205 to set volume of the first divided sound signal to zero, and sends an instruction to the fifth volume control part 209 to set volume of the first divided sound signal to predetermined volume. Further, in a case where there is a person in the first area 101, the area control part 202A sends an instruction to the first volume control part 205 to set volume of the first divided sound signal to predetermined volume, and sends an instruction to the fifth volume control part 209 to set volume of the first divided sound signal to zero.

In a case where there is no person in the second area 102, the area control part 202A sends an instruction to the second volume control part 206 to set volume of the second divided sound signal to zero, and sends an instruction to the sixth volume control part 210 to set volume of the second divided sound signal to predetermined volume. Further, in a case where there is a person in the second area 102, the area control part 202A sends an instruction to the second volume control part 206 to set volume of the second divided sound signal to predetermined volume, and sends an instruction to the sixth volume control part 210 to set volume of the second divided sound signal to zero.

In a case where there is no person in the third area 103, the area control part 202A sends an instruction to the third volume control part 207 to set volume of the third divided sound signal to zero, and sends an instruction to the seventh volume control part 211 to set volume of the third divided sound signal to predetermined volume. Further, in a case where there is a person in the third area 103, the area control part 202A sends an instruction to the third volume control part 207 to set volume of the third divided sound signal to predetermined volume, and sends an instruction to the seventh volume control part 211 to set volume of the third divided sound signal to zero.

In a case where there is no person in the fourth area 104, the area control part 202A sends an instruction to the fourth volume control part 208 to set volume of the fourth divided sound signal to zero, and sends an instruction to the eighth volume control part 212 to set volume of the fourth divided sound signal to predetermined volume. Further, in a case where there is a person in the fourth area 104, the area control part 202A sends an instruction to the fourth volume control part 208 to set volume of the fourth divided sound signal to predetermined volume, and sends an instruction to the eighth volume control part 212 to set volume of the fourth divided sound signal to zero.

The sound source reproduction part 204A outputs the first divided sound signal to the first volume control part 205 and the fifth volume control part 209, outputs the second divided sound signal to the second volume control part 206 and the sixth volume control part 210, outputs the third divided sound signal to the third volume control part 207 and the seventh volume control part 211, and outputs the fourth divided sound signal to the fourth volume control part 208 and the eighth volume control part 212.

The fifth volume control part 209 sets volume of the first divided sound signal input from the sound source reproduction part 204A to volume instructed by the area control part 202A. The fifth volume control part 209 sets volume of the first divided sound signal to predetermined volume in a case where there is no person in the first area 101, and sets volume of the first divided sound signal to zero in a case where there is a person in the first area 101.

The sixth volume control part 210 sets volume of the second divided sound signal input from the sound source reproduction part 204A to volume instructed by the area control part 202A. The sixth volume control part 210 sets volume of the second divided sound signal to predetermined volume in a case where there is no person in the second area 102, and sets volume of the second divided sound signal to zero in a case where there is a person in the second area 102.

The seventh volume control part 211 sets volume of the third divided sound signal input from the sound source reproduction part 204A to volume instructed by the area control part 202A. The seventh volume control part 211 sets volume of the third divided sound signal to predetermined volume in a case where there is no person in the third area 103, and sets volume of the third divided sound signal to zero in a case where there is a person in the third area 103.

The eighth volume control part 212 sets volume of the fourth divided sound signal input from the sound source reproduction part 204A to volume instructed by the area control part 202A. The eighth volume control part 212 sets volume of the fourth divided sound signal to predetermined volume in a case where there is no person in the fourth area 104, and sets volume of the fourth divided sound signal to zero in a case where there is a person in the fourth area 104.

The fifth volume control part 209 to the eighth volume control part 212 output a plurality of reproduced divided sound signals (the first divided sound signal to the fourth divided sound signal) to a plurality of speakers (the fifth speaker 45 to the eighth speaker 48) installed in a plurality of areas (the first area 101 to the fourth area 104), respectively. The fifth volume control part 209 outputs the first divided sound signal with set volume to the fifth speaker 45 via the fifth amplifier 35. The sixth volume control part 210 outputs the second divided sound signal with set volume to the sixth speaker 46 via the sixth amplifier 36. The seventh volume control part 211 outputs the third divided sound signal with set volume to the seventh speaker 47 via the seventh amplifier 37. The eighth volume control part 212 outputs the fourth divided sound signal with set volume to the eighth speaker 48 via the eighth amplifier 38.

The sound reproduction device 2A is connected to a plurality of amplifiers themselves or a hub (not illustrated) such as a communication device or a server in a wired or wireless manner so that a plurality of divided sound signals can be input to a plurality of amplifiers (the first amplifier 31 to the eighth amplifier 38). The sound reproduction device 2A may be communicably connected to each of a plurality of amplifiers (the first amplifier 31 to the eighth amplifier 38) via a network. The sound reproduction device 2A outputs the first divided sound signal to the first amplifier 31 and the fifth amplifier 35, outputs the second divided sound signal to the second amplifier 32 and the sixth amplifier 36, outputs the third divided sound signal to the third amplifier 33 and the seventh amplifier 37, and outputs the fourth divided sound signal to the fourth amplifier 34 and the eighth amplifier 38.

The fifth amplifier 35 amplifies the first divided sound signal input from the fifth volume control part 209 of the sound reproduction device 2A.

The sixth amplifier 36 amplifies the second divided sound signal input from the sixth volume control part 210 of the sound reproduction device 2A.

The seventh amplifier 37 amplifies the third divided sound signal input from the seventh volume control part 211 of the sound reproduction device 2A.

The eighth amplifier 38 amplifies the fourth divided sound signal input from the eighth volume control part 212 of the sound reproduction device 2A.

Note that the fifth amplifier 35 to the eighth amplifier 38 may be disposed in each area or may be disposed outside each area.

The fifth speaker 45 is disposed in the first area 101, converts the first divided sound signal amplified by the fifth amplifier 35 into the first divided sound, and emits the first divided sound toward the outside of the first area 101. In a case where volume of the first divided sound signal is set to a predetermined volume by the fifth volume control part 209, the fifth speaker 45 emits the first divided sound at the predetermined volume. In a case where volume of the first divided sound signal is set to zero by the fifth volume control part 209, the fifth speaker 45 does not emit the first divided sound.

The sixth speaker 46 is disposed in the second area 102, converts the second divided sound signal amplified by the sixth amplifier 36 into the second divided sound, and emits the second divided sound toward the outside of the second area 102. In a case where volume of the second divided sound signal is set to a predetermined volume by the sixth volume control part 210, the sixth speaker 46 emits the second divided sound at the predetermined volume. In a case where volume of the second divided sound signal is set to zero by the sixth volume control part 210, the sixth speaker 46 does not emit the second divided sound.

The seventh speaker 47 is disposed in the third area 103, converts the third divided sound signal amplified by the seventh amplifier 37 into the third divided sound, and emits the third divided sound toward the outside of the third area 103. In a case where volume of the third divided sound signal is set to a predetermined volume by the seventh volume control part 211, the seventh speaker 47 emits the third divided sound at the predetermined volume. In a case where volume of the third divided sound signal is set to zero by the seventh volume control part 211, the seventh speaker 47 does not emit the third divided sound.

The eighth speaker 48 is disposed in the fourth area 104, converts the fourth divided sound signal amplified by the eighth amplifier 38 into the fourth divided sound, and emits the fourth divided sound toward the outside of the fourth area 104. In a case where volume of the fourth divided sound signal is set to a predetermined volume by the eighth volume control part 212, the eighth speaker 48 emits the fourth divided sound at the predetermined volume. In a case where volume of the fourth divided sound signal is set to zero by the eighth volume control part 212, the eighth speaker 48 does not emit the fourth divided sound.

As described above, in each of a plurality of areas, in a case where there is no person in an area, a divided sound is emitted toward the outside of the area, so that it is possible to guide a person outside the area into the area where there is no person.

Note that in the second embodiment, the sound reproduction system includes the first speaker 41 to the fourth speaker 44 that emit the first divided sound to the fourth divided sound toward the inside of the first area 101 to the fourth area 104, and the fifth speaker 45 to the eighth speaker 48 that emit the first divided sound to the fourth divided sound toward the outside of the first area 101 to the fourth area 104, but the present disclosure is not particularly limited to this. The sound reproduction system may include one speaker in each of a plurality of areas, and a sound emission direction of each of the speakers may be changed between the inside and the outside of an area.

Further, the area control part 202A may determine whether to emit each of a plurality of divided sounds into the inside or the outside of an area according to the number of people in each of a plurality of areas or the total number of people in all of a plurality of areas. For example, in a plurality of areas, in a case where the number of people in an area is equal to or less than a predetermined number of people, the area control part 202A may cause a divided sound to be emitted to both the inside of an area and the outside of an area, and in a case where the number of people in the area is larger than the predetermined number of people, the area control part 202A may cause a divided sound to be emitted only to the inside of an area. Further, the area control part 202A may cause each of a plurality of divided sounds to be emitted to both the inside of a plurality of areas and the outside of the plurality of areas in a case where the total number of people in all of the plurality of areas is equal to or less than a predetermined number of people, and may cause each of the plurality of divided sounds to be emitted only to the inside of the plurality of areas in a case where the total number of people in all of the plurality of areas is larger than the predetermined number of people.

### Third embodiment

In the first embodiment, a plurality of speakers are disposed in each of a plurality of areas, but in a third embodiment, a speaker array that changes directivity toward a plurality of areas is disposed.

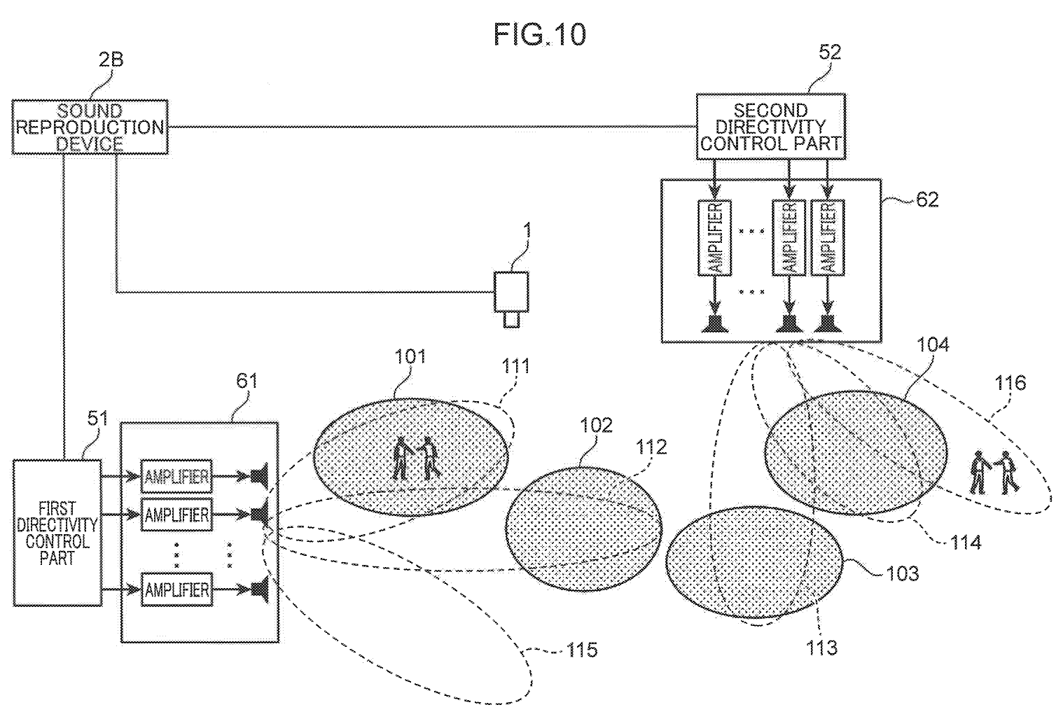

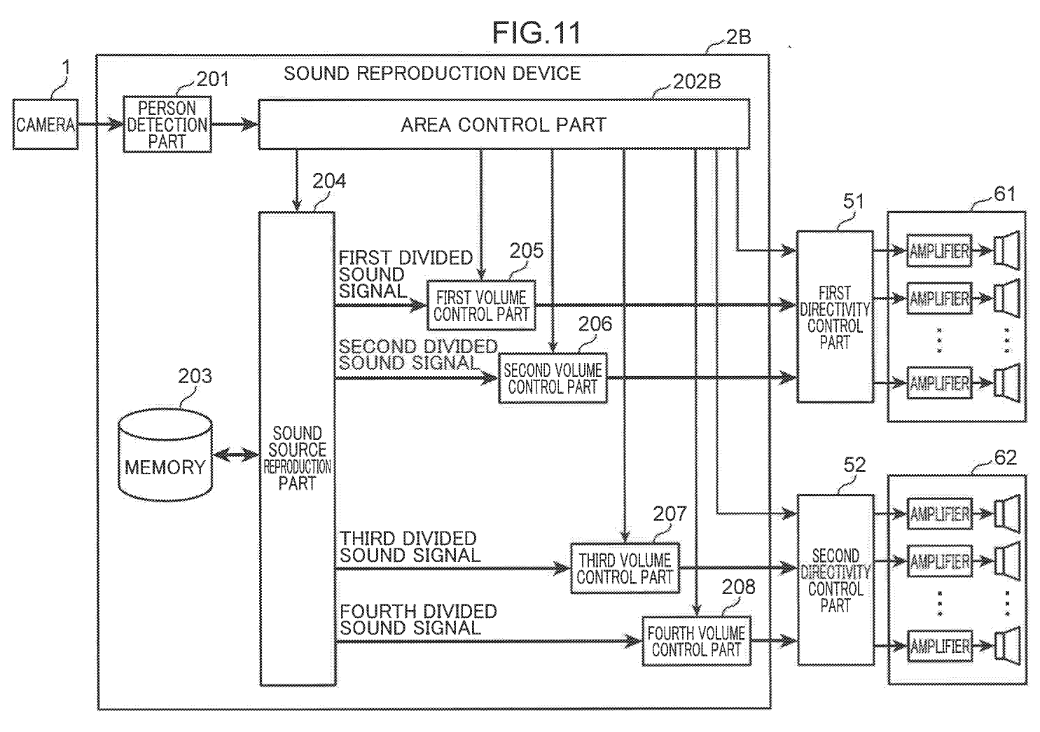

FIG. 10 is a diagram illustrating an overall configuration of the sound reproduction system according to the third embodiment, and FIG. 11 is a block diagram illustrating a configuration of a sound reproduction device 2B according to the third embodiment.

The sound reproduction system according to the third embodiment includes the camera 1, the sound reproduction device 2B, a first directivity control part 51, a second directivity control part 52, a first speaker array 61, and a second speaker array 62. Note that, in the third embodiment, the same configuration as that in the first embodiment will be denoted by the same reference sign as that in the first embodiment, and will be omitted from description.

The sound reproduction device 2B includes at least a computer system including, for example, a control program, a processing circuit such as a processor or a logic circuit that executes the control program, and a recording device such as an internal memory or an accessible external memory that stores the control program. Note that the sound reproduction device 2B may be implemented by, for example, hardware implementation by a processing circuit, execution of a software program held in a memory by a processing circuit or distributed from an external server, or a combination of these hardware implementation and software implementation.

The sound reproduction device 2B includes the person detection part 201, an area control part 202B, the memory 203, the sound source reproduction part 204, the first volume control part 205, the second volume control part 206, the third volume control part 207, and the fourth volume control part 208.

The area control part 202B acquires the number of people in each of a plurality of areas from the person detection part 201. The area control part 202B determines volume of each of a plurality of divided sound signals according to the number of people in each of a plurality of areas. In each of a plurality of areas, the area control part 202B determines volume of a divided sound signal to be a predetermined volume in a case where the number of people in the area is equal to or more than a predetermined number of people, and determines volume of a divided sound signal to be zero in a case where the number of people in the area is smaller than the predetermined number of people. The predetermined number of people is, for example, one, and the predetermined volume is, for example, maximum volume.

In a case where volume of the first divided sound signal is determined to be a predetermined volume, the area control part 202B sends an instruction to the first directivity control part 51 to set an orientation of directivity of the first speaker array 61 toward a first direction 111 in which the first area 101 exists and to emit the first divided sound toward the first direction 111. The first direction 111 is a direction from the first speaker array 61 toward the center of the first area 101.

Further, in a case where volume of the second divided sound signal is determined to be a predetermined volume, the area control part 202B sends an instruction to the first directivity control part 51 to set an orientation of directivity of the first speaker array 61 toward a second direction 112 in which the second area 102 exists and to emit the second divided sound toward the second direction 112. The second direction 112 is a direction from the first speaker array 61 toward the center of the second area 102.

Further, in a case where volume of the third divided sound signal is determined to be a predetermined volume, the area control part 202B sends an instruction to the second directivity control part 52 to set an orientation of directivity of the second speaker array 62 toward a third direction 113 in which the third area 103 exists and to emit the third divided sound toward the third direction 113. The third direction 113 is a direction from the second speaker array 62 toward the center of the third area 103.

Further, in a case where volume of the fourth divided sound signal is determined to be a predetermined volume, the area control part 202B sends an instruction to the second directivity control part 52 to set an orientation of directivity of the second speaker array 62 toward a fourth direction 114 in which the fourth area 104 exists and to emit the fourth divided sound toward the fourth direction 114. The fourth direction 114 is a direction from the second speaker array 62 toward the center of the fourth area 104.

The first volume control part 205 to the fourth volume control part 208 output each of a plurality of divided sound signals (the first divided sound signal to the fourth divided sound signal) reproduced by the sound source reproduction part 204 to at least one speaker array (the first speaker array 61 and the second speaker array 62) having directivity toward each of a plurality of areas (the first area 101 to the fourth area 104).

The first directivity control part 51 controls an orientation of directivity of the first speaker array 61 based on an instruction from the area control part 202B. In a case where the first divided sound is emitted, the first directivity control part 51 sets an orientation of directivity of the first speaker array 61 toward the first direction 111 in which the first area 101 exists. Further, in a case where the second divided sound is emitted, the first directivity control part 51 sets an orientation of directivity of the first speaker array 61 toward the second direction 112 in which the second area 102 exists.

The second directivity control part 52 controls an orientation of directivity of the second speaker array 62 based on an instruction from the area control part 202B. In a case where the third divided sound is emitted, the second directivity control part 52 sets an orientation of directivity of the second speaker array 62 toward the third direction 113 in which the third area 103 exists. Further, in a case where the fourth divided sound is emitted, the second directivity control part 52 sets an orientation of directivity of the second speaker array 62 toward the fourth direction 114 in which the fourth area 104 exists.

The first speaker array 61 includes a plurality of amplifiers and a plurality of speakers arranged in a horizontal direction. The first speaker array 61 emits the first divided sound toward the first direction 111 in which the first area 101 exists, and emits the second divided sound toward the second direction 112 in which the second area 102 exists.

The second speaker array 62 includes a plurality of amplifiers and a plurality of speakers arranged in the horizontal direction. The second speaker array 62 emits the third divided sound toward the third direction 113 in which the third area 103 exists, and emits the fourth divided sound toward the fourth direction 114 in which the fourth area 104 exists.

Note that the first speaker array 61 and the second speaker array 62 can simultaneously emit sounds in two directions.

As described above, in the third embodiment, a plurality of divided sounds can be emitted from at least one speaker array whose directivity is set toward each of a plurality of areas.

Note that the first speaker array 61 may emit the first divided sound or the second divided sound toward a fifth direction 115 in which the first area 101 and the second area 102 do not exist. Further, the second speaker array 62 may emit the third divided sound or the fourth divided sound toward a sixth direction 116 in which the third area 103 and the fourth area 104 do not exist.

In each of a plurality of areas, the area control part 202B may cause a divided sound to be emitted toward the outside of an area in a case where there is no person in the area, and cause a divided sound to be emitted toward the inside of an area in a case where there is a person in the area.

In a case where there is no person in the first area 101, the area control part 202B may instruct the first directivity control part 51 to set an orientation of directivity of the first speaker array 61 toward the fifth direction 115 in which the first area 101 and the second area 102 do not exist and emit the first divided sound toward the fifth direction 115. Further, in a case where there is a person in the first area 101, the area control part 202B may instruct the first directivity control part 51 to set an orientation of directivity of the first speaker array 61 toward the first direction 111 in which the first area 101 exists and emit the first divided sound toward the first direction 111.

In a case where there is no person in the second area 102, the area control part 202B may instruct the first directivity control part 51 to set an orientation of directivity of the first speaker array 61 toward the fifth direction 115 in which the first area 101 and the second area 102 do not exist and emit the second divided sound toward the fifth direction 115. Further, in a case where there is a person in the second area 102, the area control part 202B may instruct the first directivity control part 51 to set an orientation of directivity of the first speaker array 61 toward the second direction 112 in which the second area 102 exists and emit the second divided sound toward the second direction 112.

Note that, in a case where there is no person in neither the first area 101 nor the second area 102, the area control part 202B may instruct the first directivity control part 51 to set an orientation of directivity of the first speaker array 61 toward the fifth direction 115 in which the first area 101 and the second area 102 do not exist, and to emit the first divided sound and the second divided sound toward the fifth direction 115.

Further, in a case where there is a person in the first area 101 and there is no person in the second area 102, the area control part 202B may instruct the first directivity control part 51 to set an orientation of directivity of the first speaker array 61 toward the first direction 111 in which the first area 101 exists and the fifth direction 115 in which the first area 101 and the second area 102 do not exist, and to emit the first divided sound toward the first direction 111 and emit the second divided sound toward the fifth direction 115.

In a case where there is no person in the third area 103, the area control part 202B may instruct the second directivity control part 52 to set an orientation of directivity of the second speaker array 62 toward the sixth direction 116 in which the third area 103 and the fourth area 104 do not exist and emit the third divided sound toward the sixth direction 116. Further, in a case where there is a person in the third area 103, the area control part 202B may instruct the second directivity control part 52 to set an orientation of directivity of the second speaker array 62 toward the third direction 113 in which the third area 103 exists and emit the third divided sound toward the third direction 113.

In a case where there is no person in the fourth area 104, the area control part 202B may instruct the second directivity control part 52 to set an orientation of directivity of the second speaker array 62 toward the sixth direction 116 in which the third area 103 and the fourth area 104 do not exist and emit the fourth divided sound toward the sixth direction 116. Further, in a case where there is a person in the fourth area 104, the area control part 202B may instruct the second directivity control part 52 to set an orientation of directivity of the second speaker array 62 toward the fourth direction 114 in which the fourth area 104 exists and emit the fourth divided sound toward the fourth direction 114.

Note that, in a case where there is no person in neither the third area 103 nor the fourth area 104, the area control part 202B may instruct the second directivity control part 52 to set an orientation of directivity of the second speaker array 62 toward the sixth direction 116 in which the third area 103 and the fourth area 104 do not exist, and emit the third divided sound and the fourth divided sound toward the sixth direction 116.

Further, in a case where there is a person in the third area 103 and there is no person in the fourth area 104, the area control part 202B may instruct the second directivity control part 52 to set an orientation of directivity of the second speaker array 62 toward the third direction 113 in which the third area 103 exists and the sixth direction 116 in which the third area 103 and the fourth area 104 do not exist, and to emit the third divided sound toward the third direction 113 and emit the fourth divided sound toward the sixth direction 116.

### Fourth embodiment

In the first to third embodiments, a plurality of divided sounds obtained by dividing a predetermined sound are emitted to each of a plurality of areas, but in a fourth embodiment, a plurality of divided videos obtained by dividing a predetermined video are displayed at locations corresponding to the plurality of areas.

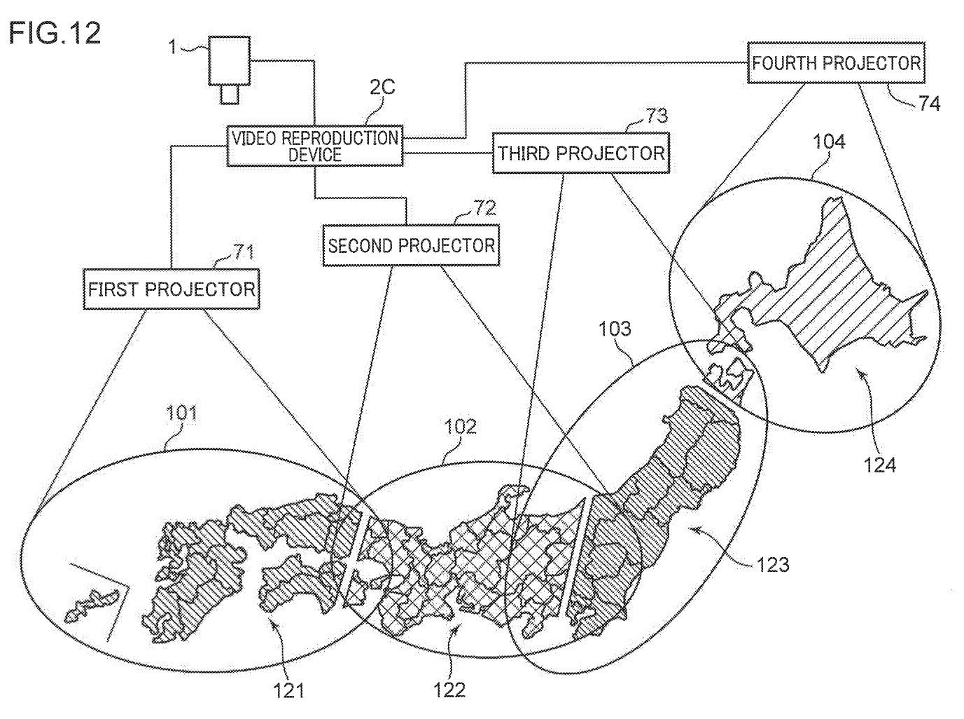

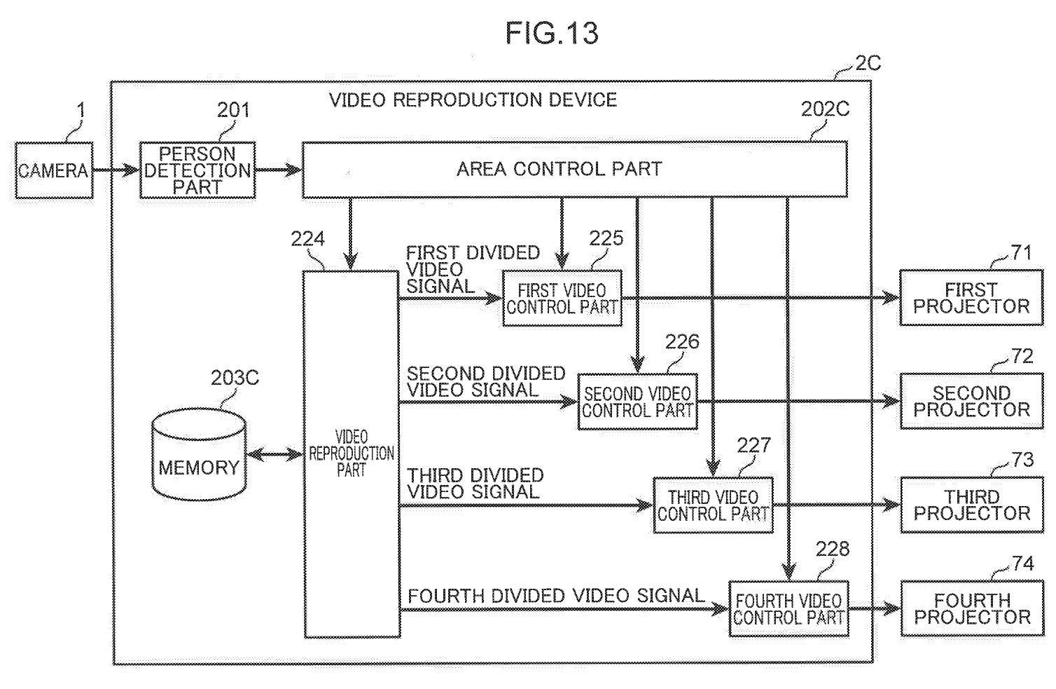

FIG. 12 is a diagram illustrating an overall configuration of a video reproduction system according to the fourth embodiment, and FIG. 13 is a block diagram illustrating a configuration of a video reproduction device 2C according to the fourth embodiment.

The video reproduction system according to the fourth embodiment includes the camera 1, the video reproduction device 2C, a first projector 71, a second projector 72, a third projector 73, and a fourth projector 74. Note that, in the fourth embodiment, the same configuration as that in the first embodiment will be denoted by the same reference sign as that in the first embodiment, and will be omitted from description.

The video reproduction device 2C synchronizes and reproduces a plurality of divided video signals obtained by dividing a predetermined video, and outputs the plurality of divided video signals to a display device that displays a plurality of divided videos converted from the plurality of divided video signals at locations corresponding to a plurality of areas. The video reproduction device 2C detects the number of people in each of the first area 101 to the fourth area 104 based on an image captured by the camera 1. The video reproduction device 2C determines whether or not to output first to fourth divided video signals according to the number of people in each of the first area 101 to the fourth area 104.

The video reproduction device 2C includes at least a computer system including, for example, a control program, a processing circuit such as a processor or a logic circuit that executes the control program, and a recording device such as an internal memory or an accessible external memory that stores the control program. Note that the video reproduction device 2C may be implemented by, for example, hardware implementation by a processing circuit, execution of a software program held in a memory by a processing circuit or distributed from an external server, or a combination of these hardware implementation and software implementation.

The video reproduction device 2C includes the person detection part 201, an area control part 202C, a memory 203C, a video reproduction part 224, a first video control part 225, a second video control part 226, a third video control part 227, and a fourth video control part 228.

The area control part 202C outputs a reproduction start instruction for starting reproduction of a predetermined video to the video reproduction part 224. The area control part 202C outputs a reproduction start instruction to the video reproduction part 224 at predetermined reproduction start time. Further, the area control part 202C may output a reproduction end instruction for ending reproduction of a predetermined video to the video reproduction part 224. The area control part 202C may output a reproduction end instruction to the video reproduction part 224 at predetermined reproduction end time.

in a case where a person is detected in any of a plurality of areas, the area control part 202C may output a reproduction start instruction to the video reproduction part 224. Further, in a case where no person is detected in any of a plurality of areas, the area control part 202C may output a reproduction end instruction to the video reproduction part 224.

Further, the area control part 202C may select a video corresponding to a current time period from among a plurality of videos of different types, and output a reproduction start instruction for starting reproduction of the selected video to the video reproduction part 224. For example, the area control part 202C may select a video corresponding to a current time period among a first video corresponding to a time period in the morning (8:00 AM to 12:00 PM), a second video corresponding to a time period in the afternoon (12:00 PM to 6:00 PM), and a third video corresponding to a time period in the night (6:00 PM to 10:00 PM). Note that the time period is not limited to the above.

Further, the area control part 202C may select a video corresponding to the current weather from among a plurality of videos of different types, and output a reproduction start instruction for starting reproduction of the selected video to the video reproduction part 224. For example, the area control part 202C may acquire weather information from the Internet, determine the current weather such as sunny, cloudy, rainy, or snowy from the acquired weather information, and reproduce a video according to the determination result.

Further, the area control part 202C may select a video corresponding to the current season from among a plurality of videos of different types, and output a reproduction start instruction for starting reproduction of the selected video to the video reproduction part 224. For example, the area control part 202C may acquire the current calendar month, determine the current season such as spring, summer, autumn, or winter from the acquired month, and reproduce a video according to the determination result. Further, the area control part 202C may acquire information on outside temperature from the Internet, determine the current season from the acquired outside temperature, and reproduce a video according to the determination result.

The area control part 202C acquires the number of people in each of a plurality of areas from the person detection part 201. The area control part 202C determines whether or not to output each of a plurality of divided video signals according to the number of people in each of a plurality of areas. The area control part 202C determines whether or not to output the first divided video signal according to the number of people in the first area 101, and sends an instruction to the first video control part 225 indicating the determination result. The area control part 202C determines whether or not to output the second divided video signal according to the number of people in the second area 102, and sends an instruction to the second video control part 226 indicating the determination result. The area control part 202C determines whether or not to output the third divided video signal according to the number of people in the third area 103, and sends an instruction to the third video control part 227 indicating the determination result. The area control part 202C determines whether or not to output the fourth divided video signal according to the number of people in the fourth area 104, and sends an instruction to the fourth video control part 228 indicating the determination result.

In each of a plurality of areas, the area control part 202C determines to output a divided video signal in a case where the number of people in an area is equal to or more than a predetermined number of people, and determines not to output a divided video signal in a case where the number of people in an area is smaller than the predetermined number of people. The predetermined number of people is, for example, one. For example, in each of a plurality of areas, the area control part 202C may determine to output a divided video signal in a case where the number of people in an area is one or more, and determine not to output a divided video signal in a case where the number of people in an area is less than one, that is, in a case where the number of people in an area is 0. Note that the predetermined number of people is not limited to one, and may be two or more, such as three or five.

The memory 203C stores in advance a plurality of divided video signals obtained by dividing a predetermined video. The memory 203C stores the first divided video signal, the second divided video signal, the third divided video signal, and the fourth divided video signal in advance. Note that the memory 203C may store a plurality of videos in advance. The number of a plurality of divided video signals may be the same as or different from the number of a plurality of areas. The predetermined video may be a still image or a moving image. Further, in which area each of a plurality of divided videos is displayed is determined in advance.

In the example illustrated in FIG. 12, the predetermined video is an image representing a map of Japan. A first divided video 121 is displayed in the first area 101, a second divided video 122 is displayed in the second area 102, a third divided video 123 is displayed in the third area 103, and a fourth divided video 124 is displayed in the fourth area 104. When all of the first divided video 121 to the fourth divided video 124 are displayed, one video (map of Japan) is completed.

The video reproduction part 224 synchronizes and reproduces a plurality of divided video signals obtained by dividing a predetermined video. The video reproduction part 224 reads a plurality of divided video signals from the memory 203. When a reproduction start instruction is input from the area control part 202C, the video reproduction part 224 starts reproduction of a plurality of divided video signals obtained by dividing a predetermined video. Further, when a reproduction end instruction is input from the area control part 202C, the video reproduction part 224 ends reproduction of a plurality of divided video signals obtained by dividing a predetermined video.

The video reproduction part 224 synchronizes and reproduces all of the first to fourth divided video signals regardless of whether there is a person in each of the first area 101 to the fourth area 104.

The video reproduction part 224 outputs the first divided video signal to the first video control part 225, outputs the second divided video signal to the second video control part 226, outputs the third divided video signal to the third video control part 227, and outputs the fourth divided video signal to the fourth video control part 228.

The first video control part 225 to the fourth video control part 228 output a plurality of divided video signals reproduced by the video reproduction part 224 to a projector that displays, at locations corresponding to a plurality of areas, a plurality of divided videos converted from a plurality of divided video signals. Further, the first video control part 225 to the fourth video control part 228 control output of each of a plurality of divided video signals according to the number of people in each of a plurality of areas.

The first video control part 225 controls output of the first divided video signal according to the number of people in the first area 101. In a case where the area control part 202C determines to output the first divided video signal, the first video control part 225 outputs the first divided video signal input from the video reproduction part 224 to the first projector 71. In a case where the area control part 202C determines not to output the first divided video signal, the first video control part 225 does not output the first divided video signal input from the video reproduction part 224 to the first projector 71.

The second video control part 226 controls output of the second divided video signal according to the number of people in the second area 102. In a case where the area control part 202C determines to output the second divided video signal, the second video control part 226 outputs the second divided video signal input from the video reproduction part 224 to the second projector 72. In a case where the area control part 202C determines not to output the second divided video signal, the second video control part 226 does not output the second divided video signal input from the video reproduction part 224 to the second projector 72.

The third video control part 227 controls output of the third divided video signal according to the number of people in the third area 103. In a case where the area control part 202C determines to output the third divided video signal, the third video control part 227 outputs the third divided video signal input from the video reproduction part 224 to the third projector 73. In a case where the area control part 202C determines not to output the third divided video signal, the third video control part 227 does not output the third divided video signal input from the video reproduction part 224 to the third projector 73.

The fourth video control part 228 controls output of the fourth divided video signal according to the number of people in the fourth area 104. In a case where the area control part 202C determines to output the fourth divided video signal, the fourth video control part 228 outputs the fourth divided video signal input from the video reproduction part 224 to the fourth projector 74. In a case where the area control part 202C determines not to output the fourth divided video signal, the fourth video control part 228 does not output the fourth divided video signal input from the video reproduction part 224 to the fourth projector 74.

The first video control part 225 to the fourth video control part 228 output a plurality of divided video signals (the first divided video signal to the fourth divided video signal) reproduced by the video reproduction part 224 to a plurality of projectors (the first projector 71 to the fourth projector 74) installed in a plurality of areas (the first area 101 to the fourth area 104), respectively.

The video reproduction device 2C is connected to a plurality of projectors themselves or a hub (not illustrated) such as a communication device or a server in a wired or wireless manner so that a plurality of divided video signals can be input to a plurality of projectors (the first projector 71 to the fourth projector 74). The video reproduction device 2C may be communicably connected to each of a plurality of projectors (the first projector 71 to the fourth projector 74) via a network. The video reproduction device 2C outputs the first divided video signal to the first projector 71, outputs the second divided video signal to the second projector 72, outputs the third divided video signal to the third projector 73, and outputs the fourth divided video signal to the fourth projector 74.

The first projector 71 to the fourth projector 74 are examples of a display device.

The first projector 71 is disposed in the first area 101, and displays the first divided video converted from the first divided video signal in the first area 101. In a case where the first divided video signal is input, the first projector 71 displays the first divided video in the first area 101. For example, the first projector 71 projects the first divided video onto the ground in the first area 101.

The second projector 72 is disposed in the second area 102, and displays the second divided video converted from the second divided video signal in the second area 102. In a case where the second divided video signal is input, the second projector 72 displays the second divided video in the second area 102. For example, the second projector 72 projects the second divided video onto the ground in the second area 102.

The third projector 73 is disposed in the third area 103, and displays the third divided video converted from the third divided video signal in the third area 103. In a case where the third divided video signal is input, the third projector 73 displays the third divided video in the third area 103. For example, the third projector 73 projects the third divided video onto the ground in the third area 103.

The fourth projector 74 is disposed in the fourth area 104, and displays the fourth divided video converted from the fourth divided video signal in the fourth area 104. In a case where the fourth divided video signal is input, the fourth projector 74 displays the fourth divided video in the fourth area 104. For example, the fourth projector 74 projects the fourth divided video onto the ground in the fourth area 104.

Next, video reproduction processing by the video reproduction device 2C in the fourth embodiment of the present disclosure will be described.

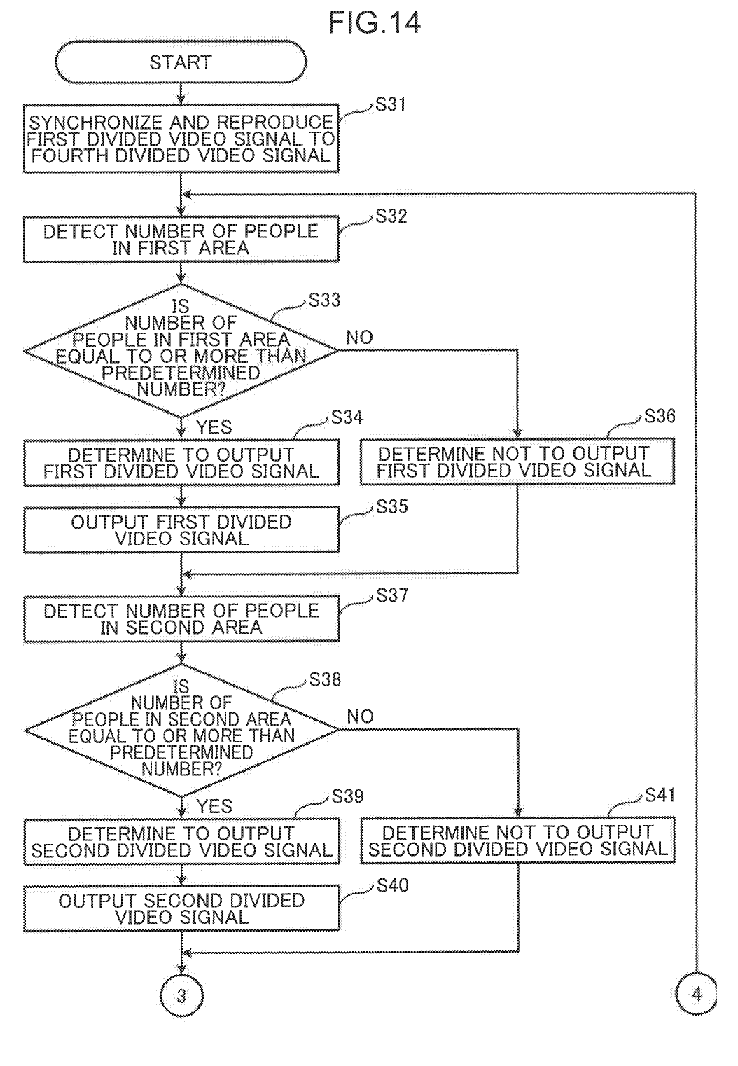

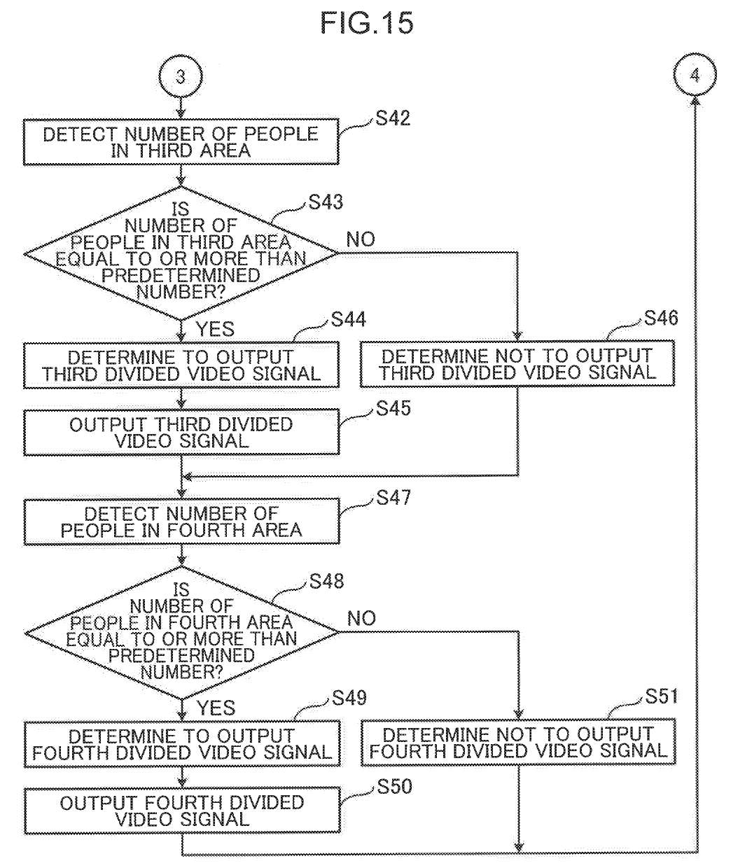

FIG. 14 is a first flowchart for explaining the video reproduction processing by the video reproduction device 2C in the fourth embodiment of the present disclosure, and FIG. 15 is a second flowchart for explaining the video reproduction processing by the video reproduction device 2C in the fourth embodiment of the present disclosure.

First, in Step S31, the video reproduction part 224 synchronizes and reproduces the first to fourth divided video signals obtained by dividing a predetermined video. At this time, the area control part 202C outputs a reproduction start instruction for starting reproduction of a predetermined video to the video reproduction part 224. When the reproduction start instruction is input from the area control part 202C, the video reproduction part 224 reads the first to fourth divided video signals from the memory 203C, and synchronizes and reproduces the read first to fourth divided video signals. The video reproduction part 224 outputs the reproduced first to fourth divided video signals to the first video control part 225 to the fourth video control part 228, respectively.

Next, in Step S32, the person detection part 201 detects the number of people in the first area 101 based on an image captured by the camera 1. The person detection part 201 outputs the detected number of people in the first area 101 to the area control part 202C. The area control part 202C acquires the number of people in the first area 101 from the person detection part 201.

Next, in Step S33, the area control part 202C determines whether or not the number of people in the first area 101 is equal to or more than a predetermined number of people. The predetermined number of people is, for example, one.

Here, in a case where it is determined that the number of people in the first area 101 is equal to or more than the predetermined number of people (YES in Step S33), the area control part 202C determines to output the first divided video signal in Step S34. The area control part 202C sends an instruction to the first video control part 225 to output the first divided video signal.

Next, in Step S35, the first video control part 225 outputs the first divided video signal to the first projector 71. The first projector 71 displays the first divided video converted from the first divided video signal in the first area 101.

On the other hand, in a case where it is determined that the number of people in the first area 101 is not equal to or more than the predetermined number of people, that is, in a case where it is determined that the number of people in the first area 101 is smaller than the predetermined number of people (NO in Step S33), the area control part 202C determines not to output the first divided video signal in Step S36. The area control part 202C sends an instruction to the first video control part 225 not to output the first divided video signal. In this case, the first video control part 225 does not output the first divided video signal based on the instruction from the area control part 202C.

By the above, when the number of people in the first area 101 is equal to or more than the predetermined number of people, the first divided video is displayed (projected) from the first projector 71, and when the number of people in the first area 101 is smaller than the predetermined number of people, the first divided video is not displayed (projected) from the first projector 71.

Next, in Step S37, the person detection part 201 detects the number of people in the second area 102 based on an image captured by the camera 1. The person detection part 201 outputs the detected number of people in the second area 102 to the area control part 202C. The area control part 202C acquires the number of people in the second area 102 from the person detection part 201.

Next, in Step S38, the area control part 202C determines whether or not the number of people in the second area 102 is equal to or more than a predetermined number of people. The predetermined number of people is, for example, one.

Here, in a case where it is determined that the number of people in the second area 102 is equal to or more than the predetermined number of people (YES in Step S38), the area control part 202C determines to output the second divided video signal in Step S39. The area control part 202C sends an instruction to the second video control part 226 to output the second divided video signal.

Next, in Step S40, the second video control part 226 outputs the second divided video signal to the second projector 72. The second projector 72 displays the second divided video converted from the second divided video signal in the second area 102.

On the other hand, in a case where it is determined that the number of people in the second area 102 is not equal to or more than the predetermined number of people, that is, in a case where it is determined that the number of people in the second area 102 is smaller than the predetermined number of people (NO in Step S38), the area control part 202C determines not to output the second divided video signal in Step S41. The area control part 202C sends an instruction to the second video control part 226 not to output the second divided video signal. In this case, the second video control part 226 does not output the second divided video signal based on the instruction from the area control part 202C.

By the above, when the number of people in the second area 102 is equal to or more than the predetermined number of people, the second divided video is displayed (projected) from the second projector 72, and when the number of people in the second area 102 is smaller than the predetermined number of people, the second divided video is not displayed (projected) from the second projector 72.

Next, in Step S42, the person detection part 201 detects the number of people in the third area 103 based on an image captured by the camera 1. The person detection part 201 outputs the detected number of people in the third area 103 to the area control part 202C. The area control part 202C acquires the number of people in the third area 103 from the person detection part 201.

Next, in Step S43, the area control part 202C determines whether or not the number of people in the third area 103 is equal to or more than a predetermined number of people. The predetermined number of people is, for example, one.

Here, in a case where it is determined that the number of people in the third area 103 is equal to or more than the predetermined number of people (YES in Step S43), the area control part 202C determines to output the third divided video signal in Step S44. The area control part 202C sends an instruction to the third video control part 227 to output the third divided video signal.

Next, in Step S45, the third video control part 227 outputs the third divided video signal to the third projector 73. The third projector 73 displays the third divided video converted from the third divided video signal in the third area 103.

On the other hand, in a case where it is determined that the number of people in the third area 103 is not equal to or more than the predetermined number of people, that is, in a case where it is determined that the number of people in the third area 103 is smaller than the predetermined number of people (NO in Step S43), the area control part 202C determines not to output the third divided video signal in Step S46. The area control part 202C sends an instruction to the third video control part 227 not to output the third divided video signal. In this case, the third video control part 227 does not output the third divided video signal based on the instruction from the area control part 202C.

By the above, when the number of people in the third area 103 is equal to or more than the predetermined number of people, the third divided video is displayed (projected) from the third projector 73, and when the number of people in the third area 103 is smaller than the predetermined number of people, the third divided video is not displayed (projected) from the third projector 73.

Next, in Step S47, the person detection part 201 detects the number of people in the fourth area 104 based on an image captured by the camera 1. The person detection part 201 outputs the detected number of people in the fourth area 104 to the area control part 202C. The area control part 202C acquires the number of people in the fourth area 104 from the person detection part 201.

Next, in Step S48, the area control part 202C determines whether or not the number of people in the fourth area 104 is equal to or more than a predetermined number of people. The predetermined number of people is, for example, one.

Here, in a case where it is determined that the number of people in the fourth area 104 is equal to or more than the predetermined number of people (YES in Step S48), the area control part 202C determines to output the fourth divided video signal in Step S49. The area control part 202C sends an instruction to the fourth video control part 228 to output the fourth divided video signal.

Next, in Step S50, the fourth video control part 228 outputs the fourth divided video signal to the fourth projector 74. The fourth projector 74 displays the fourth divided video converted from the fourth divided video signal in the fourth area 104.

On the other hand, in a case where it is determined that the number of people in the fourth area 104 is not equal to or more than the predetermined number of people, that is, in a case where it is determined that the number of people in the fourth area 104 is smaller than the predetermined number of people (NO in Step S48), the area control part 202C determines not to output the fourth divided video signal in Step S51. The area control part 202C sends an instruction to the fourth video control part 228 not to output the fourth divided video signal. In this case, the fourth video control part 228 does not output the fourth divided video signal based on the instruction from the area control part 202C.

By the above, when the number of people in the fourth area 104 is equal to or more than the predetermined number of people, the fourth divided video is displayed (projected) from the fourth projector 74, and when the number of people in the fourth area 104 is smaller than the predetermined number of people, the fourth divided video is not displayed (projected) from the fourth projector 74.

As described above, since a plurality of divided videos that are synchronized and reproduced are displayed at locations corresponding to a plurality of areas, the plurality of divided videos overlap each other inside the plurality of areas, and one harmonious video is displayed. Therefore, since people outside the plurality of areas can be guided to the inside of the plurality of areas, the people outside the plurality of areas can be gathered to the inside of the plurality of areas.

Note that in the fourth embodiment, a plurality of areas may not overlap each other, or parts of a plurality of areas may overlap each other. For example, a part of the first area 101 and a part of the second area 102 may overlap each other. In a case where there is a person in a portion where a part of the first area 101 and a part of the second area 102 overlap, the first divided video may be displayed in the first area 101 and the second divided video may be displayed in the second area 102.

Further, in the fourth embodiment, a plurality of divided videos are displayed (projected) in a plurality of areas, but the present disclosure is not particularly limited to this, and a plurality of divided videos may be displayed (projected) on a single screen that can be viewed from a plurality of areas. In this case, the single screen may be divided into a plurality of portions corresponding to a plurality of areas, and a plurality of divided videos may be displayed (projected) on each of the plurality of portions.

Further, in a modification example of the fourth embodiment, a single display device may display a plurality of divided videos instead of a plurality of projectors projecting a plurality of divided videos on a single screen.

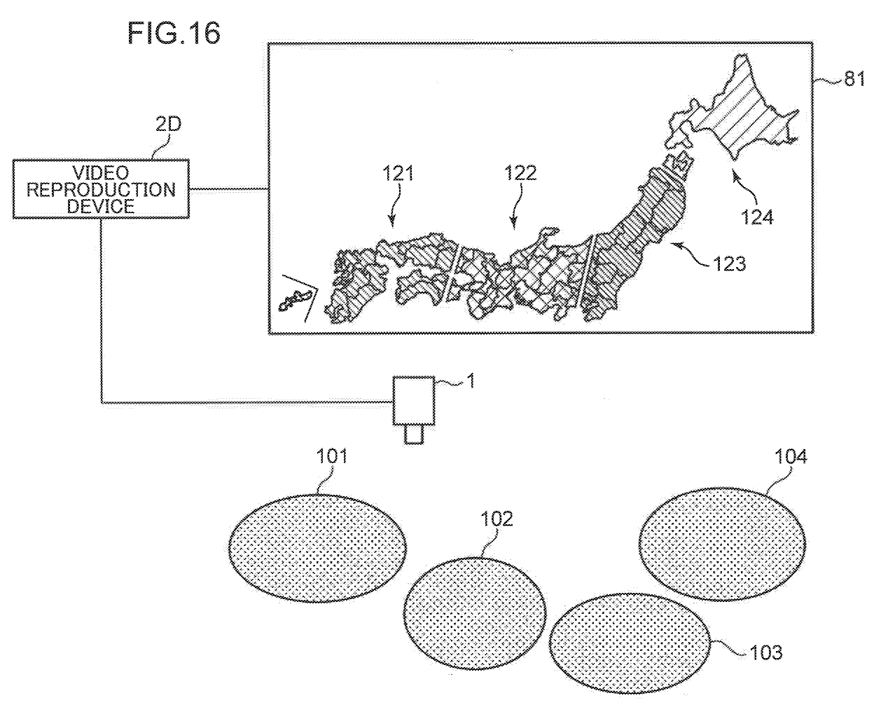

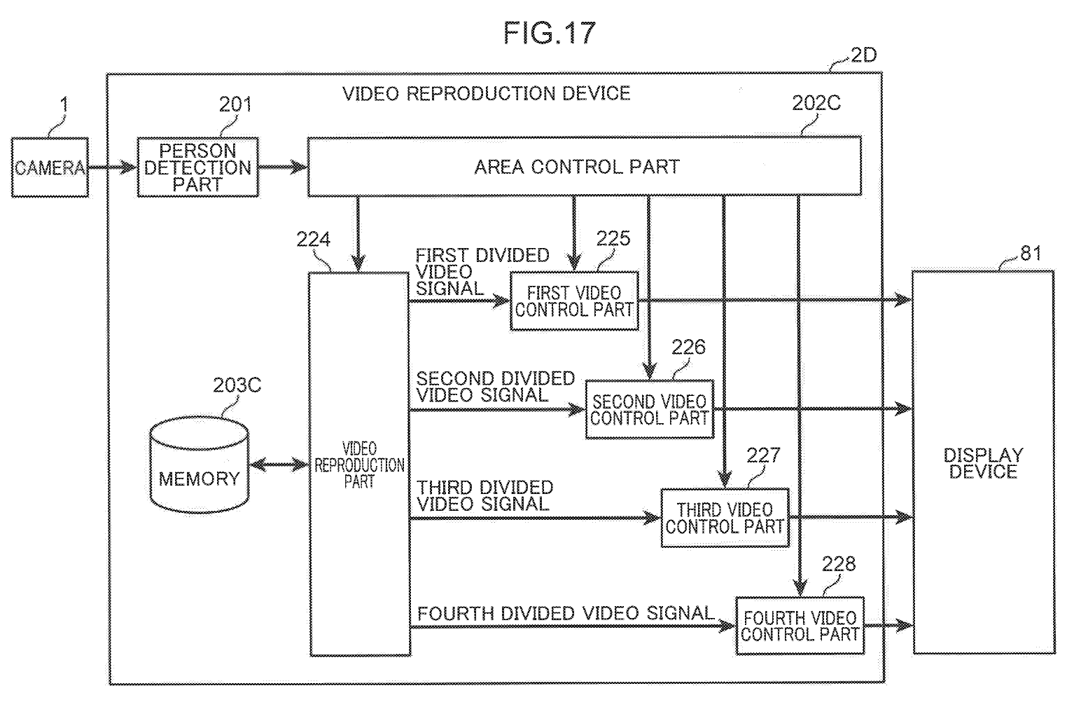

FIG. 16 is a diagram illustrating an overall configuration of the video reproduction system according to the modification example of the fourth embodiment, and FIG. 17 is a block diagram illustrating a configuration of a video reproduction device 2D according to the modification example of the fourth embodiment.

The video reproduction system according to the modification example of the fourth embodiment includes the camera 1, the video reproduction device 2D, and a display device 81. Note that, in the modification example of the fourth embodiment, the same configuration as that in the fourth embodiment will be denoted by the same reference sign as that in the fourth embodiment, and will be omitted from description.

The display device 81 is, for example, a large Light Emitting Diode (LED) display, and is disposed at a location visible from the first area 101 to the fourth area 104.

The video reproduction device 2D synchronizes and reproduces a plurality of divided video signals obtained by dividing a predetermined video, and outputs the plurality of divided video signals to the display device 81 that displays a plurality of divided videos converted from the plurality of divided video signals at positions on a screen corresponding to a plurality of areas. The video reproduction device 2D detects the number of people in each of the first area 101 to the fourth area 104 based on an image captured by the camera 1. The video reproduction device 2D determines whether or not to output the first to fourth divided video signals according to the number of people in each of the first area 101 to the fourth area 104.

The video reproduction device 2D includes at least a computer system including, for example, a control program, a processing circuit such as a processor or a logic circuit that executes the control program, and a recording device such as an internal memory or an accessible external memory that stores the control program. Note that the video reproduction device 2D may be implemented by, for example, hardware implementation by a processing circuit, execution of a software program held in a memory by a processing circuit or distributed from an external server, or a combination of these hardware implementation and software implementation.

The video reproduction device 2D includes the person detection part 201, the area control part 202C, the memory 203C, the video reproduction part 224, the first video control part 225, the second video control part 226, the third video control part 227, and the fourth video control part 228.

The memory 203C stores in advance a plurality of divided video signals obtained by dividing a predetermined video. The memory 203C stores the first divided video signal, the second divided video signal, the third divided video signal, and the fourth divided video signal in advance. Note that the memory 203C may store a plurality of videos in advance. The number of a plurality of divided video signals may be the same as or different from the number of a plurality of areas. The predetermined video may be a still image or a moving image. Further, a display position corresponding to an area for displaying each of a plurality of divided videos is determined in advance.

In the example illustrated in FIG. 16, the predetermined video is an image representing a map of Japan. The display device 81 displays the first divided video 121 at a display position corresponding to the first area 101, displays the second divided video 122 at a display position corresponding to the second area 102, displays the third divided video 123 at a display position corresponding to the third area 103, and displays the fourth divided video 124 at a display position corresponding to the fourth area 104. When all of the first divided video 121 to the fourth divided video 124 are displayed, one video (map of Japan) is completed.

The first video control part 225 to the fourth video control part 228 output a plurality of divided video signals reproduced by the video reproduction part 224 to the display device 81 that displays, at locations corresponding to a plurality of areas, a plurality of divided videos converted from a plurality of divided video signals. Further, the first video control part 225 to the fourth video control part 228 control output of each of a plurality of divided video signals according to the number of people in each of a plurality of areas.

The first video control part 225 controls output of the first divided video signal according to the number of people in the first area 101. In a case where the area control part 202C determines to output the first divided video signal, the first video control part 225 outputs the first divided video signal input from the video reproduction part 224 to the display device 81. In a case where the area control part 202C determines not to output the first divided video signal, the first video control part 225 does not output the first divided video signal input from the video reproduction part 224 to the display device 81.

The second video control part 226 controls output of the second divided video signal according to the number of people in the second area 102. In a case where the area control part 202C determines to output the second divided video signal, the second video control part 226 outputs the second divided video signal input from the video reproduction part 224 to the display device 81. In a case where the area control part 202C determines not to output the second divided video signal, the second video control part 226 does not output the second divided video signal input from the video reproduction part 224 to the display device 81.

The third video control part 227 controls output of the third divided video signal according to the number of people in the third area 103. In a case where the area control part 202C determines to output the third divided video signal, the third video control part 227 outputs the third divided video signal input from the video reproduction part 224 to the display device 81. In a case where the area control part 202C determines not to output the third divided video signal, the third video control part 227 does not output the third divided video signal input from the video reproduction part 224 to the display device 81.

The fourth video control part 228 controls output of the fourth divided video signal according to the number of people in the fourth area 104. In a case where the area control part 202C determines to output the fourth divided video signal, the fourth video control part 228 outputs the fourth divided video signal input from the video reproduction part 224 to the display device 81. In a case where the area control part 202C determines not to output the fourth divided video signal, the fourth video control part 228 does not output the fourth divided video signal input from the video reproduction part 224 to the display device 81.

The first video control part 225 to the fourth video control part 228 output each of a plurality of divided video signals (the first divided video signal to the fourth divided video signal) reproduced by the video reproduction part 224 to the display device 81 installed at a position visible from each of a plurality of the areas (the first area 101 to the fourth area 104).

The video reproduction device 2D is connected to the display device 81 itself or a hub (not illustrated) such as a communication device or a server in a wired or wireless manner so that a plurality of divided video signals can be input to the display device 81. The video reproduction device 2D may be communicably connected to the display device 81 via a network. The video reproduction device 2D outputs the first divided video signal, the second divided video signal, the third divided video signal, and the fourth divided video signal to the display device 81.

The display device 81 displays the first divided video converted from the first divided video signal at a first display position corresponding to the first area 101. In a case where the first divided video signal is input, the display device 81 displays the first divided video at the first display position corresponding to the first area 101.

The display device 81 displays the second divided video converted from the second divided video signal at a second display position corresponding to the second area 102. In a case where the second divided video signal is input, the display device 81 displays the second divided video at the second display position corresponding to the second area 102.

The display device 81 displays the third divided video converted from the third divided video signal at a third display position corresponding to the third area 103. In a case where the third divided video signal is input, the display device 81 displays the third divided video at the third display position corresponding to the third area 103.

The display device 81 displays the fourth divided video converted from the fourth divided video signal at a fourth display position corresponding to the fourth area 104. In a case where the fourth divided video signal is input, the display device 81 displays the fourth divided video at the fourth display position corresponding to the fourth area 104.

Further, in a case where a single video is projected on a single screen, a video of a plurality of color components corresponding to a plurality of areas may be projected as a plurality of divided videos. For example, when there is a person in the first area, the first divided video of a red component may be projected, when there is a person in the second area, a second divided video of a green component may be projected, and when there is a person in the third area, the third divided video of a blue component may be projected. Then, a single color video may be displayed as a plurality of divided videos corresponding to a plurality of color components overlap each other.

Further, in a case where a single video is projected on a single screen, a background video may be continuously projected, and a plurality of divided images may be projected in a manner superimposed on the background video. For example, when there is a person in the first area, the first divided video in which a person is playing the guitar may be projected, when there is a person in the second area, the second divided video in which a person is playing the bass may be projected, when there is a person in the third area, the third divided video in which a person is playing the drum may be projected, and when there is a person in the fourth area, the fourth divided video in which a person is playing the keyboard may be projected.

Further, the sound reproduction system of the first to third embodiments may include the video reproduction device 2C and the first projector 71 to the fourth projector 74 of the fourth embodiment. Further, the sound reproduction devices 2 to 2B of the first to third embodiments may include the area control part 202C, the memory 203C, the video reproduction part 224, the first video control part 225, the second video control part 226, the third video control part 227, and the fourth video control part 228 of the video reproduction device 2C. That is, the sound reproduction devices 2 to 2B of the first to third embodiments may further synchronize and reproduce a plurality of divided video signals obtained by dividing a predetermined video, and output the plurality of divided video signals to a display device that displays a plurality of divided videos converted from the plurality of divided video signals at locations corresponding to a plurality of areas.

In this case, the predetermined video may be video content linked with a predetermined sound in the sound reproduction system of the first to third embodiments. For example, in a case where the predetermined sound is a series of musical pieces by performance of a plurality of musical instruments, the predetermined video may be a video showing each performance of the plurality of musical instruments.

Further, each of a plurality of divided video signals may include content corresponding to each of a plurality of divided sound signals. For example, when there is a person in the first area and a first divided sound representing a guitar sound is emitted, the first divided video in which the person is playing the guitar may be projected, when there is a person in the second area and a second divided sound representing a bass sound is emitted, the second divided video in which the person is playing the bass may be projected, when there is a person in the third area and the third divided sound representing a drum sound is emitted, the third divided video in which the person is playing the drum may be projected, and when there is a person in the fourth area and the fourth divided sound representing a keyboard sound is emitted, the fourth divided video in which the person is playing the keyboard may be projected.

Note that in each of the above embodiments, each component may be implemented by being configured with dedicated hardware or by execution of a software program suitable for each component. Each component may be implemented by a program execution part, such as a CPU or a processor, reading and executing a software program recorded on a recording medium such as a hard disk or a semiconductor memory. Further, a program may be executed by another independent computer system by recording and transferring the program on a recording medium or transferring the program via a network.

Some or all functions of the devices according to the embodiments of the present disclosure are implemented as Large Scale Integration (LSI) which is typically an integrated circuit. These may be individually integrated into one chip, or may be integrated into one chip so as to include some or all of these. Further, circuit integration is not limited to LSI, and may be implemented by a dedicated circuit or a general-purpose processor. A Field Programmable Gate Array (FPGA) that can be programmed after manufacturing of LSI or a reconfigurable processor in which connection and setting of circuit cells inside the LSI can be reconfigured may be used.

Further, some or all functions of the device according to the embodiments of the present disclosure may be implemented by a processor such as a CPU executing a program.

Further, the numerical figures used above are all illustrated to specifically describe the present disclosure, and the present disclosure is not limited to the illustrated numerical figures.

Order in which each step illustrated in the above flowchart is executed is exemplified for specifically describing the present disclosure, and may be any order other than the above as long as a similar effect can be obtained. Further, some of the above steps may be executed simultaneously (in parallel) with other steps.

The technique according to the present disclosure is useful as a technique for reproducing a sound because people outside a plurality of areas can be gathered inside the plurality of areas.

1. A sound reproduction method in a computer, the sound reproduction method comprising:
synchronizing and reproducing a plurality of divided sound signals obtained by dividing a predetermined sound; and
outputting the plurality of divided sound signals to a speaker that emits a plurality of divided sounds converted from the plurality of divided sound signals to each of a plurality of areas.

2. The sound reproduction method according to claim 1, further comprising:
acquiring number of people in each of the plurality of areas; and
controlling volume of each of the plurality of divided sound signals according to number of people in each of the plurality of areas.

3. The sound reproduction method according to claim 2, wherein control of the volume includes determining volume of a divided sound signal to be a predetermined volume in a case where a number of people in an area is equal to or more than a predetermined number of people in each of the plurality of areas, and determining volume of the divided sound signal to be zero in a case where the number of people in the area is smaller than the predetermined number of people.

4. The sound reproduction method according to claim 1, wherein the predetermined sound is divided according to frequency.

5. The sound reproduction method according to claim 1, wherein the predetermined sound is music and is divided according to a plurality of performance parts forming the music.

6. The sound reproduction method according to claim 1, wherein the predetermined sound is a natural sound and is divided according to a plurality of elements forming the natural sound.

7. The sound reproduction method according to claim 2, further comprising:
causing a divided sound to be emitted toward the outside of an area in a case where there is no person in the area, and causing the divided sound to be emitted toward the inside of the area in a case where there is a person in the area for each of the plurality of areas.

8. The sound reproduction method according to claim 1, wherein outputting the plurality of divided sound signals includes outputting each of the plurality of reproduced divided sound signals to each of a plurality of speakers installed in each of the plurality of areas.

9. The sound reproduction method according to claim 1, wherein outputting the plurality of divided sound signals includes outputting each of the plurality of reproduced divided sound signals to at least one speaker array having directivity set to each of the plurality of areas.

10. The sound reproduction method according to claim 2, further comprising:
changing the predetermined sound according to a total number of people in all of the plurality of areas.

11. The sound reproduction method according to claim 2, further comprising:
determining whether to emit each of the plurality of divided sounds to inside or outside of an area according to number of people in each of the plurality of areas or a total number of people in all of the plurality of areas.

12. The sound reproduction method according to claim 2, further comprising:
acquiring volume of voice of a person in each of the plurality of areas,
wherein control of the volume includes changing volume of each of the plurality of divided sound signals according to the volume of the voice in each of the plurality of areas.

13. The sound reproduction method according to claim 2, further comprising:
acquiring an activity amount of a person in each of the plurality of areas,
wherein control of the volume includes changing volume of each of the plurality of divided sound signals according to the activity amount in each of the plurality of areas.

14. The sound reproduction method according to claim 1, further comprising:
synchronizing and reproducing a plurality of divided video signals obtained by dividing a predetermined video; and
outputting the plurality of divided video signals to a display device that displays a plurality of divided videos converted from the plurality of divided video signals at locations corresponding to a plurality of areas.

15. A sound reproduction device comprising:
a reproduction part that synchronizes and reproduces a plurality of divided sound signals obtained by dividing a predetermined sound; and
an output part that outputs the plurality of divided sound signals to a speaker that emits a plurality of divided sounds converted from the plurality of divided sound signals to each of a plurality of areas.

16. A non-transitory computer readable recording medium storing a sound reproduction program that causes a computer to function to:
synchronize and reproduce a plurality of divided sound signals obtained by dividing a predetermined sound; and
output the plurality of divided sound signals to a speaker that emits a plurality of divided sounds converted from the plurality of divided sound signals to each of a plurality of areas.
